(19) United States
(12) Patent Application Publication
(10) Pub. No.: US 2014/0317019 A1
(43) Pub. Date: Oct. 23, 2014

(54) SYSTEM AND METHOD FOR RISK MANAGEMENT AND PORTFOLIO OPTIMIZATION

(71) Applicants: Jochen Papenbrock, Oberursel (DE); Peter Schwendner, Augsburg (DE)

(72) Inventors: Jochen Papenbrock, Oberursel (DE); Peter Schwendner, Augsburg (DE)

(21) Appl. No.: 14/213,986

(22) Filed: Mar. 14, 2014

Related U.S. Application Data
(60) Provisional application No. 61/781,718, filed on Mar. 14, 2013.

(51) Int. Cl. G06Q 40/06

(52) U.S. Cl. CPC G06Q 40/06
USPC 705/36 R

(57) ABSTRACT

A processor-based analytical system accesses financial data for a group of assets over a plurality of time periods and identifies relationship characteristics for the financial data during those time periods. The system compares the relationship characteristics to compute pair-wise similarity measures, which are used to group different time periods into states. The system also accesses information identifying an investment portfolio, such as information identifying particular assets in that portfolio as well as the weightings of those assets in the portfolio. The system evaluates the performance of the portfolio in the states. The system alters the investment portfolio by altering the weightings of the assets in the investment portfolio in order to achieve a predetermined investment goal.

### CROSS-REFERENCE TO RELATED APPLICATION

The present application claims priority to U.S. Provisional Application No. 61/781,718, entitled STATISTICAL METHOD FOR MANAGING RISK AND FOR PORTFOLIO OPTIMIZATION, filed on Mar. 14, 2013, the contents of which are incorporated herein by reference in their entirety for all purposes.

### TECHNICAL FIELD

Embodiments of the present invention generally relate to the fields of risk management and financial investment analysis. More specifically, embodiments of the present invention relate to systems and methods for analyzing financial data for assets in an investment market and for modifying or selecting individual investment portfolios based on that analysis.

### BACKGROUND

Investors currently choose from a variety of investment options in many investment markets. Exemplary investment markets include stocks, bonds, currencies, futures, ETFs, investable indices, etc. Many investment portfolios include assets from these investment markets in varying quantities or weightings. Each asset or investment option carries its own unique risks and potentials for returns, such that each investment portfolio will likewise carry a unique risk and potential for returns. Modifying the weightings of the assets in the investment portfolio will alter the overall performance and risk of the investment portfolio.

### SUMMARY

According to some embodiments, a processor-based analytical system accesses financial data for a group of assets over a plurality of time periods. The system analyzes the financial data for the assets during the time periods to identify relationship characteristics for the financial data. For example, the system may compute a correlation matrix for the group of assets for each time period. The financial data used for that correlation matrix may include returns, prices, trading volumes, open interest, bid/ask spreads, among others. The system may also, or alternatively, compute a return for each one of the set of assets during a particular time period. This asset return vector is computed for one or more of the plurality of time periods. The system then compares the relationship characteristics (e.g., the correlation matrices and/or return vectors) over the time periods to compute pair-wise similarity measures, which are used to group different time periods into states. Thus, a state may include several discontinuous time periods. The system also accesses information identifying an investment portfolio, such as information identifying particular assets in that portfolio as well as the weightings of those assets in the portfolio. The system evaluates the performance of the portfolio in at least one of the states (i.e., in each of the time periods forming that state). The performance of the portfolio may, for instance, be evaluated in terms of a return measure, a risk-adjusted measure, a reward or utility measure, among others. The system may then alter the investment portfolio, for example, by altering the weightings of the assets in the investment portfolio, in order to achieve a predetermined investment goal, such as maximizing portfolio performance or achieving a certain level of investment risks. According to some embodiments, the system creates a network model or a cluster model of the portfolio. The network model or cluster model may represent the assets in one or more states. The system may include a display to convey a graphical representation of the network model or cluster model. The network or cluster model may be used to optimize the investment portfolio.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates an exemplary networked environment in accordance with embodiments of the present invention and in which embodiments of the present invention may operate.

FIG. 2A illustrates an exemplary computer in accordance with embodiments of the present invention.

FIG. 2B illustrates an exemplary computer server in accordance with embodiments of the present invention.

FIG. 3 illustrates steps used to compute correlation matrices in accordance with embodiments of the present invention.

FIG. 4 illustrates steps used to create states and state correlation matrices using the correlation matrices of FIG. 3 in accordance with embodiments of the present invention.

FIG. 5 illustrates steps used to augment a set of states with financial data for a new time window in accordance with embodiments of the present invention.

FIG. 6 illustrates steps used to forecast correlation matrices using transition probabilities between states in accordance with embodiments of the present invention.

FIG. 7 illustrates steps used to alter an investment portfolio using a set of states and network modeling or clustering in accordance with embodiments of the present invention.

FIG. 8 illustrates steps used to alter an investment portfolio using a set of states and a ranking process for the set of states in accordance with embodiments of the present invention.

FIG. 9 illustrates a heat map that depicts a similarity matrix between time periods and associated states in accordance with embodiments of the present invention.

FIG. 10 illustrates a state correlation matrix as it is transformed into a correlation network and into a filtered correlation network in accordance with embodiments of the present invention.

FIG. 11 illustrates a state correlation matrix and three associated correlation clusters in accordance with embodiments of the present invention.

FIG. 12 illustrates the transformation of a correlation matrix into a distance matrix and an ultrametric or cophenetic matrix, as well as a dendrogram illustrating distances between assets in accordance with embodiments of the present invention.

FIG. 13 illustrates an exemplary filtered network diagram in accordance with embodiments of the present invention.

FIG. 14 illustrates a dendrogram that is separated into four clusters in accordance with embodiments of the present invention.

FIG. 15 illustrates a network diagram created using community detection techniques in accordance with embodiments of the present invention.

FIG. 16 illustrates a diagram depicting the outcome of state detections and evaluations in accordance with embodiments of the present invention.

FIG. 17 illustrates heat maps of two correlation matrices, each one of them representing a different state. in accordance with embodiments of the present invention.

FIG. 18 illustrates a network diagram in which industry memberships are highlighted and node sizes reflect network centrality in accordance with embodiments of the present invention.

FIG. 19 illustrates a visualization of partitional asset clusters, in accordance with embodiments of the present invention.

FIG. 20 illustrates a graph whose lines track assets through various clusters in accordance with embodiments of the present invention.

FIG. 21 illustrates a chart showing the occurrence of asset clusters in all states in accordance with embodiments of the present invention.

FIGS. 22A-C illustrate how the same correlation network for set of assets can be drawn with different indicia to highlight different community schemes in accordance with embodiments of the present invention.

FIG. 23 illustrates a chart depicting how a correlation matrix can be transformed into a network or into a hierarchical or partitional cluster in accordance with embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

According to embodiments of the present invention, financial data for investment assets are used to optimize an investment portfolio. As described below in more detail, the financial data includes information regarding returns, prices, trading process, trading volume, among others, for assets in investment markets. The financial data spans multiple time periods or windows. By analyzing the financial data and identifying particular time segments during which the financial data describing the investment assets exhibit certain similar relationship characteristics (e.g., periods in which the financial data for the assets are similarly correlated), the overall market behavior can be described in terms of states. Each state defines one or more discrete time periods in which the financial data describing the investment assets exhibit those similar relationship characteristics. Once the states are defined, an investment portfolio may be analyzed in view of the states to evaluate the performance of the portfolio in each state. Based on the results of that analysis, the individual portfolio may be modified to optimize performance or to achieve a pre-defined investment goal.

In some embodiments, the assets of the portfolio are selected from the larger group of assets whose financial data are analyzed to identify the states. In other embodiments, the assets of the portfolio are the group of assets whose financial data are analyzed to identify the states. In yet other embodiments, the group of assets whose financial data are analyzed to identify the states forms only a portion of the investment portfolio. Assets do not necessarily have to be real assets but also synthetic assets with some simulated time series (e.g. by random drawings).

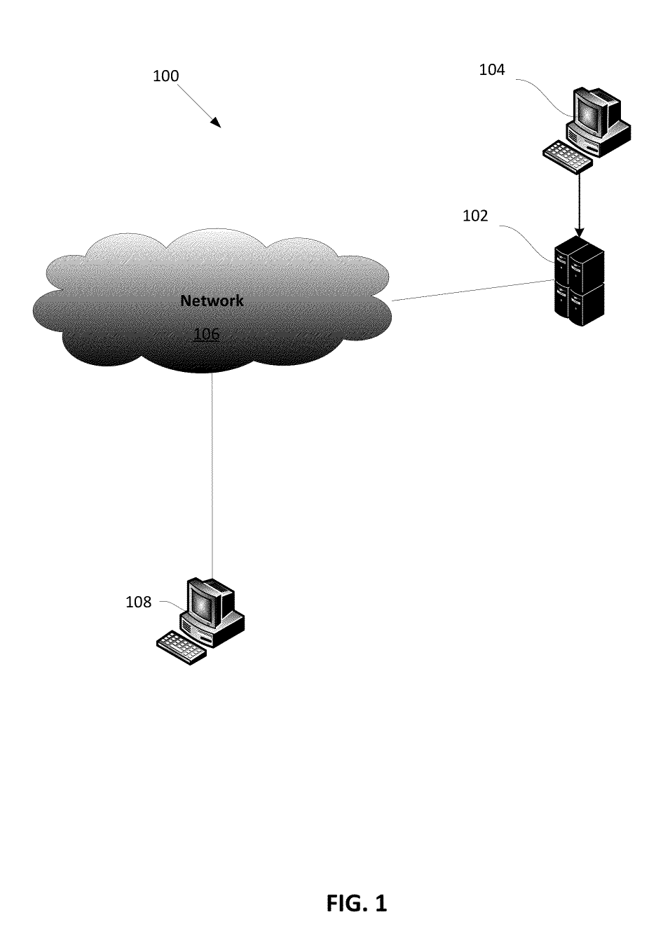

Many of the embodiments described herein utilize various combinations of processor-based components and/or tangible, non-transitory storage media. For example, in some embodiments the volume of data and the complexity of the calculations are too great for an individual to process without at least some automation. Exemplary components that may be used, in whole or in part, in those embodiments are shown in FIG. 1. Specifically, FIG. 1 depicts a networked environment 100 that includes a server 102 and a first computer 104. The server 102 and the first computer 104 are connected to a first network 106, such as the Internet. Also connected to the first network 106 is a second computer 108, which could also be a server or any other processor-based component. The network 106 may be, e.g., the Internet, a local area network, a local intranet, or a cell phone network. While FIG. 1 depicts a small networked environment, in some embodiments the networked environment 100 includes a plurality of servers 102 and computers 104, 108.

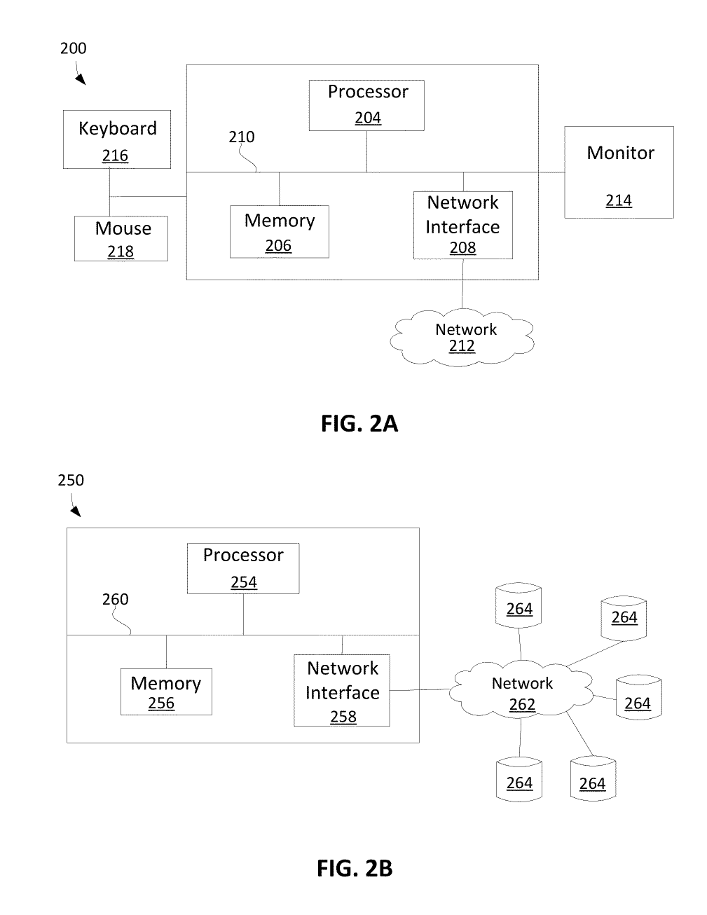

FIG. 2A illustrates a computer system 200, and aspects thereof, that may serve as the first computer 104 or any other computer. The illustrated computer system 200 includes a processor 204 coupled to a memory 206 and a network interface 208 through a bus 210. The network interface 208 is also coupled to a network 212 such as the Internet. The computer system 200 may further include a monitor 214, a keyboard 216, and a mouse 218. In other embodiments, the computer system 200 may use other mechanisms for data input/output and may include a plurality of components (e.g., a plurality of memories 206 or buses 210). FIG. 2B illustrates a computer server 250 and aspects thereof, which may serve as a server 102. The illustrated computer server 250 includes a processor 254 coupled to a memory 256 and a network interface 258 through a bus 260. The network interface 258 is also coupled to a network 262 such as the Internet. In other embodiments, the computer server 250 may include a plurality of components (e.g., a plurality of memories 256 or buses 260). The network 262 may include a remote data storage system including a plurality of remote storage units 264 configured to store data at remote locations. Each remote storage unit 264 may be network addressable storage. In some embodiments, the computer system 200 and/or the computer server 250 include a computer-readable medium containing instructions that cause the processor 254 to perform specific functions that will be described in more detail below. That medium may include a hard drive, a disk, memory, or a transmission, among other computer-readable media.

As one of ordinary skill in the art will readily appreciate, many of the mathematical techniques described herein may be implemented using commercial programs and libraries, for example, MATLAB® and its associated libraries or toolboxes. For particular examples, the open-source “R Project for Statistical Computing” offers R-packages “stats” and “cluster” that are shipped with the base installation. Also, there are several graph modeling R-packages like igraph and RBGL. In MATLAB®, there is the statistics toolbox and the MatlabBGL for graph modeling. All named R- and MATLAB® packages also contain visualization functions for clusters, dendrograms, networks and other charting figures. Alternative software platforms like Octave, SPSS, Mathematica, Stata, and SAS are also suitable to implement several of the mathematical techniques described herein.

Before describing the particular functions that may be performed by the processor-based components described above, the following list identifies various terms used herein:

Investment Assets: Financial instruments such as stocks, bonds, currencies, futures, ETFs, investable indices, etc. A collection of weighted investment assets constitutes an investment portfolio. Weights can be positive, zero, or negative. Negative weights would correspond to short positions in the respective assets.

Financial Data: Information regarding an investment asset, such as returns, prices, trading volume, open interest, bid/ask spreads, Electronic Payment Transactions, or information that could influence its price or liquidity, among others. Examples for information that could influence prices or liquidity of investment assets are levels and changes of macroeconomic data, corporate or political news, results of economic forecasts or surveys, regulatory changes, disruptions in trading, and central bank communications or actions.

Financial Time Series: A series of financial data over multiple reporting periods.

Performance of Investment Assets: The performance of an investment asset or assets can be expressed in terms of returns, risks, diversification, dispersion or deviation of returns, rewards, gains, or utility measure, or the ratios thereof (e.g., return/risk is one risk-adjusted performance measure). Returns, for example, can be computed as “continuous/logarithmic,” “discrete/percentage/geometric,” or “arithmetic.” Examples of performance measures that are well understood in the art are Standard/Semi Deviation, Volatility, Value-at-Risk (at a certain confidence level), Sharpe Ratio, Calmar Ratio, Expected Shortfall, Tail/Conditional Value at Risk, Expected Tail Loss, Worst Draw Down, and Conditional Drawdown at Risk. These measures can be generated for a single asset or for a portfolio of assets where the asset weight vector or vectors are known. For risk measures like portfolio Value-at-risk, it is possible to decompose the total portfolio VaR into the risk contributions of each of the assets in a portfolio. Such decomposition is possible in a financially meaningful way. An implementation can be found in R's package “PerformanceAnalytics.” This package also covers the above mentioned performance and risk measures as well as ratios. Another type of risk contribution of an asset can be measured by its tail dependence with a broad market index or other assets. Tail dependence measures the probability of a joint extreme return move of the broad index and the asset. Under risk perspectives it can be favorable to decrease and investment with the tendency to crash together with the broad market. One of ordinary skill in the art will appreciate that other metrics may be employed to evaluate the performance of an investment asset as well as the overall investment portfolio comprised of investment assets. In addition, performance measures are often specified as excess, average, expected, realized, or annualized. If the portfolio weightings are known it is possible to compute multiple performance measures (including, e.g., all of the measures identified above) for the portfolio. Also, as discussed below in more detail, it is possible to identify risk or performance contributions of each asset with respect to the overall portfolio performance.

One simple exemplary technique for computing performance measures on a portfolio level is to compute the return time series of the portfolio as sum of the weighted return series across assets in a first step and then to compute return and risk of the portfolio using this portfolio return time series in a second step. The return of the portfolio is computed as the average return across the time series, and the risk is computed as volatility, which is defined as the standard deviation of returns, scaled by the square root of the inverse of one time period. To compute the average of continuous (or “logarithmic”) returns, a simple arithmetic average return is computed. To compute the average of discrete (or “percentage”) returns with reinvestment, the geometric average of these returns is computed. The Sharpe ratio of the investment portfolio could be calculated by computing the difference of the average return to the risk-free interest rate in a first step and then by dividing this difference by the volatility. Another exemplary technique is a multi-variate risk measure (e.g. based on copulas) of the portfolio, which is a common technique employed in the art.

Thus, there are a variety of mechanisms for evaluating the performance of investment assets. Accordingly, performance within a predefined range could therefore mean, for example, “a Sharpe ratio greater than 0.7” or “a volatility smaller than 20%” or any other predetermined, objective criteria selected using any one or more of the mechanisms for evaluating the performance of investment assets. The performance characteristics of sets of assets, e.g., a portfolio of investment assets, can also be defined independently from the weightings of the assets. For example, the system could use an equally weighted portfolio as a benchmark. Another example creates an evaluation that is focused on the diversification properties of the assets. In particular, an asset correlation network is generated in the first step. The asset correlation network is a network where each network node is an asset and each link corresponds to a correlation relationship between a pair of assets. The amount of edges can be reduced due to some network filtering technique, like the minimum spanning tree, which will be discussed in more detail below. In a second step, the network centralization is computed, which is a normalized measure describing the overall centrality of the network topology. Network centralization enables the system to examine the extent to which a whole graph has a centralized structure. The concepts of density (describing the general level of cohesion in a graph) and centralization refer to differing aspects of the overall “compactness” of a graph. Centralization describes the extent to which this cohesion is organized around particular points. Centralization and density, therefore, are important complementary measures. Centralization can be, for example, constructed from point centrality. Point centrality is simply the measurement of a node's centrality in a network. Standard point centrality measures are degrees (i.e., number of links of a node) or “betweenness” (i.e., number of smallest paths in a network going through a specific node). These point centrality measures are converted into measures of the overall level of centralization of a network. A graph centralization measure is an expression of how tightly the graph is organized around its most central point.

There are several types of graph centralization. The general procedure involved in this measure of graph centralization is to look at the differences between the centrality scores of the most central point and those of all other points. Centralization, then, is the ratio of the actual sum of differences to the maximum possible sum of differences. Most centralization measures based on the standard point centrality measures vary from 0 to 1 and that a value of 1 is achieved on many standard measures for graphs structured in the form of a “star” or “wheel.” Graph centralization can easily be implemented, for example, with R's igraph package where many point centrality measures are readily available. Under this approach of centralization, more compact and centralized networks are can be associated with a “less diversified” performance characteristic, for example.

Another performance characteristic independent of asset weightings in a portfolio is the relative centrality of a subset of the set of assets. For an example of this characteristic, the relative centrality of the banking sector is well understood within in a multi-industry set of stocks. Alternatively, a partitional asset clustering for the sets of assets can be computed, in which case the number of clusters indicate how compact and undiversified a set of assets is. The term partitional clustering will be explained in detail below. The clustering can be compared to an external asset classification, like asset class or industry code. The greater the difference between the analyzed cluster structure and the external classification, the more unusual are the current relationship characteristics for the set of assets. Finally, there are established metrics that can be used to characterize the hierarchical cluster structure. Examples of these metrics are compactness, deepness, shrinkage or nestedness of the hierarchical cluster, and one of ordinary skill in the art would appreciate other metrics that could be used. Typical crisis structures can be extracted from the clusterings or network generations, and are important to identify because they often have an impact on performance.

Another exemplary technique for evaluation performance characteristics without factoring in portfolio weighting involves taking the set of assets, generating a network or clustering topology for those assets, and then deriving risk-related information based on the network or cluster topology. This risk-related information can come from a general market analysis. For example, general market analysis has identified that star-like network topologies correspond to risky market phases or crises.

Relationship of Investment Assets: Correlation is one relationship measure between assets. As one of ordinary skill will readily understand, correlation can be computed based on Person or in a ranked version based on Kendall or Spearman. The Pearson correlation of two return time series is calculated as the covariance of these two return time series, divided by the product of the standard deviations of both return time series. The covariance of a return time series is calculated as the average value of the product of both returns for each time period minus the product of the mean values of both returns time series. Correlation is a symmetric linear relationship, and there can also be asymmetric and non-linear relationship measures like Tail Correlation. Other examples of relationship quantification are mutual information, semi correlation, (Granger) Causality, and Influence. Also, there are cluster or network-based relationships like the same cluster membership or a neighborhood in a network. One of ordinary skill in the art will appreciate that other metrics may be employed to evaluate relationships between investment assets. Relationships can be expressed as distances, such that two identical assets have full relationship and therefore zero distance. Distances often fulfill the properties of a metric. Examples for distances are correlations distance, Euclidean Distance or Angular Distance.

Similarity/Dissimilarity/Proximity of a Set of Assets at Different Time Periods: A similarity/dissimilarity/proximity of relationship characteristics of a set of assets can be measured with respect to different time periods. For example, the returns or volatilities of the assets can be measured at two different time periods and the return/volatility vectors at the two different time periods can be compared, e.g. by an Angular or Euclidean distance. If the distance is zero, the set of assets is identical in the two time periods. Comparing each time period to all other time periods leads to a distance matrix or similarity matrix. Another example involves comparing correlation matrices calculated for the set of assets over different time periods. A simple definition of similarity between two correlation matrices is the mean of the absolute values of the differences between all corresponding elements of the two correlation matrices: In a first step, the two correlation matrices are subtracted to get a difference matrix. In the second step, the mean of the absolute values of all elements of this difference matrix is computed. Instead of directly comparing that correlation matrices element-by-element, an alternative approach is to first transform each correlation matrix into a hierarchical or partitional clustering or a financial network and then compare the clusterings/networks in order to generate a measure of similarity of two time periods. The comparison of two hierarchical clusterings can be done by the cophenetic correlation coefficient (CPCC; will be explained in detail below). The comparison of two partitional clusterings can be done by the (adjusted) Rand Index. In particular, given a set of elements in S and two partitional clusterings of S which we call X and Y, the following holds:
a is the number of pairs of elements that are in the same set in X and in the same set in Y,
b is the number of pairs of elements that are in different sets in X and in different sets in Y,
c is the number of pairs of elements that are in the same set in X and in different sets in Y,
d is the number of pairs of elements that are in different sets in X and in the same set in Y,

Then the Rand index is (a+b)/(a+b+c+d). In other words, a+b is the number of agreements between X and Y, and c+d is the number of disagreements between X and Y. Implementations of the Rand index and extensions of it to correct for random effects can be found, for example, in R's package fpc. The comparisons by two networks can be done by their edge survival rate. The one step edge survival is defined as

$$ES ( 1 , t ) = \frac{1}{N - 1} \vert {E}^{t} ⋂ {E}^{t - 1} \vert ,$$

where E^{t} refers to the set of edges of the MST at time t and the ∩ operation intersects the two MSTs. So it is simply the fraction of surviving edges to all edges. This measure plotted in time indicates if there are major edge rewirings due to market disruptions. The edge data sets of different networks can easily be accessed in packages like R's igraph. It is then straightforward to compute the edge survival ratio or the lifetime of an edge in a sequence of networks, i.e., in which networks a specific edge occurs and how long it remains there in the sequence of networks under observation.

Combinations of performance or risk of each asset, and/or correlations among the assets can also be used to measure the similarity of different time periods. A time period can also include non-sequential dates, like a non-sequential collection of the daily returns of a market state.

Discrete/Partitional Clustering: A mathematical way to group similar objects in several classes so that objects in one class are similar and objects from different classes are very dissimilar. These classes are called “clusters”. Other expressions for discrete clustering are flat or partitional clustering. In many standard clustering algorithms, like k-means, the user has to predefine the number of clusters (i.e., “k”) in which the data will be partitioned. Standard cluster analysis in statistics is the grouping of data objects with similar properties. The idea is that objects with similar properties can be found in the same cluster and that the objects in different clusters don't share this property. There is “hard clustering,” which means it is clear to which cluster an object belongs. Alternatively, there is “soft or fuzzy clustering,” where an object is owned in portions by several cluster. There is also the possibility that an object can't be attributed to any cluster, which is a classical outlier. Also, there are overlapping cluster structures where an object can belong to several clusters. Many of the standard algorithms for cluster analysis are already shipped in the base version of R. Others can for example be found in R's package fpc. In practice, there are partition/grouping/clustering quality measures like average silhouette width to evaluate the partition quality with k clusters and to vary k accordingly to optimize the partition quality. Other clustering approaches find a number of clusters intrinsically/directly without any partition quality measures. The latter is called true cluster mining. A distance matrix or similarity matrix between asset relationships corresponding to different time periods can be clustered into groups of similar time periods. These groups are called “states” and can be used to characterize the time periods. These clustering techniques, including true cluster mining, will be readily understood by one of ordinary skill in the art. A well-known representative of partitional clustering is the k-means algorithm. It aims to partition n observations into k clusters in which each observation belongs to the cluster with the nearest mean, serving as a prototype of the cluster. The objective of the k-means algorithm is to partition n elements in k sets so as to minimize the within-cluster sum of squares (“WCSS”). Each “square” is the square between the difference of each element to the mean of each set. A common implementation is an algorithm that alternates between two steps. In the first (“assignment”) step, each element is assigned to the cluster whose mean yields the least within-cluster sum of squares (WCSS). In the second (“update”) step, the new values for the means are recalculated based on the new assignments. This algorithm has converged when the assignments no longer change.

Hierarchical Clustering, including Single-Linkage Clustering: This type of clustering identifies a hierarchy of data rather than discrete clusters. This can be either top-down or bottom-up. Typical standard approaches are single linkage, average linkage, or complete linkage hierarchical clustering. A result of the nested hierarchy can be represented as dendrograms. Time periods can be clustered into a hierarchy. A well-known representative of hierarchical clustering is the single linkage procedure. In the beginning of the process, each element is in a cluster of its own. The clusters are then sequentially combined into larger clusters, until all elements end up being in the same cluster. At each step, the two clusters separated by the shortest distance are combined. The definition of ‘shortest distance’ is what differentiates between the different agglomerative clustering methods. In single-linkage clustering, the link between two clusters is made by a single element pair, namely those two elements (one in each cluster) that are closest to each other. The shortest of these links that remains at any step causes the fusion of the two clusters whose elements are involved. The method is also known as nearest neighbor clustering. The result of the clustering can be visualized as a dendrogram, which shows the sequence of cluster fusion and the distance at which each fusion took place.

At each step when clusters are combined, it is possible to not use the shortest distance for combination but the average or the complete distance of all involved cluster elements. This results in the linkage procedures “average” and “complete” linkage. In fuzzy clustering, each asset has probabilities to which cluster it belongs. It is also possible to define a hierarchy of time periods, so the term “states” has a different meaning in this context. For example, at the first split in the dendrogram, the set of time periods are divided into two groups. Each group has an internal hierarchical cluster structure splitting the set again and again until the model reaches a “down level” where each dendrogram branch corresponds to a single time period.

Financial Network, Network Clusters, and Network Communities, including Minimum Spanning Trees (MST): These are network representations of dependences between financial assets. A matrix of pairwise dependence between markets/assets/investments can be, for example, topologically filtered in order to achieve a filtered network. Examples techniques include the use of standard algorithms like Threshold Network, Minimum Spanning Tree or Planar Maximally Filtered Graphs (PMFG) or extensions of the PMFG (e.g. with less or more filtering, with other genus) or Influence, Granger Causality or Partial Correlation Networks. Clustered assets in relatively dense regions in a network are often called network communities. These techniques will be readily understood by one of ordinary skill in the art.

An MST is constructed in the following way: there is an ordered list of ascending distances taken from the lower triangle of a distance matrix. The lowest pairwise distances are taken and added as edges to the network of nodes. Whenever a new edge creates a cycle in the network, that edge is dropped and the next edge is tested. The test for the next edge may be executed within, for example, test algorithms included in most standard graph software packages like igraph in R. This is done until there are no more distances in the ordered list remaining. The result is a spanning tree (a tree without cycles) that has the lowest possible distances chosen as edges. That is why it is called “minimum”. The distances in turn represent the highest correlations of the relationship model. A PMFG is constructed similar to the MST, (in fact, it even contains the PMFG) but has more links. The PMFG starts with a list of ascending pairwise distances. Those distances are sequentially added to graph until the list is empty. Edges are dropped if the resulting graph does not fulfil a planarity test. In graph theory, the planarity testing problem is the algorithmic problem of testing whether a given graph is a planar graph (that is, whether it can be drawn in the plane without edge intersections). The MATLAB® and R package BGL, for example, contains such a planarity test routine, and one of skill in the art would readily understand these graphs theory techniques.

Threshold networks start with a fully connected network representing the full set of pairwise asset correlations of the matrix. All correlations below a certain threshold are then cut out. This can be generalized to a directed network where each edge is directed into one or two directions (from node a to node b and/or from node b to node a). Alternatively, there are threshold cutting techniques that remove directed edges that are below or above a certain threshold.

It is also possible to transform the asset correlation matrix to absolute correlations first and then construct a network from those absolute correlations. For example, with cross-currency time series it is possible to include an asset reflecting the exchange rate EUR/USD. Another asset is included that reflects the reciprocal of the EUR/USD time series, which is simply USD/EUR. The correlation value between the return time series of these two assets would be −1, as the second asset has the inverse quotation of the first. If the network is to be constructed with the objective of interpreting these two assets as conveying the same information, it should be based on absolute correlations. The Granger causality test is a statistical hypothesis test for determining whether one time series is useful in forecasting another thus finding predictive causality. The time series of one asset is said to Granger-cause the time series of another asset if it can be shown, usually through a series oft-tests and F-tests on lagged values of the first asset (and with lagged values of the second asset also included), that those values of the first asset provide statistically significant information about future values of the second asset. The application of the Granger causality test would be readily understood to one of ordinary skill in the art.

Partial correlation measures the degree of association between two random variables, with the effect of removing a set of controlling random variables. The partial correlation between the returns X and Y controlling for the return Z is defined as the difference between a correlation between X and Y and the product of the removable correlations, divided by the product of the coefficients of alienation of the removable correlations between X and Z and between Z and Y. The coefficient of alienation of a correlation pair is the square root of one minus the square of this correlation pair. The dependency or influence network approach provides a new model level analysis of the activity and topology of directed networks. The approach extracts causal topological relations between the network's nodes (when the network structure is analyzed), and provides an important step towards inference of causal activity relations between the network nodes (when analyzing the network activity). These networks can be reduced by thresholds or by filtering techniques like MST or PMFG. The difference or discrepancy of two networks can generally be described by edge matching, which identifies edges that occur in both networks or/and edges that occur on one asset and not on another.

In the study of complex networks, a network is said to have community structure if the nodes of the network can be easily grouped into (potentially overlapping) sets of nodes, such that each set of nodes is densely connected internally. Modularity is the strength of division of a network into modules (also called groups, clusters or communities). Networks with high modularity have dense connections between the nodes within modules but sparse connections between nodes in different modules. Modularity is often used in optimization methods for detecting community structure in networks. A network is said to have community structure if the nodes of the network can be easily grouped into (potentially overlapping) sets of nodes, such that each set of nodes is densely connected internally. There can be overlapping and non-overlapping and hierarchical communities. In the particular case of non-overlapping community finding, this implies that the network divides naturally into groups of nodes with dense connections internally and sparser connections between groups. But overlapping communities are also allowed. The more general definition is based on the principle that pairs of nodes are more likely to be connected if they are both members of the same community (or communities), and less likely to be connected if they do not share communities. An example for community detection is the clique percolation technique (which is available, e.g., in R). This technique first constructs a network and then looks for dense regions called network communities. The clique percolation algorithm generates overlapping communities.

Function of an Asset within Network or Clustering: Once a network or cluster structure is generated based on a set of assets, each asset in the set has a function, or role or position, in the network or cluster structure. For example, an asset can be in the decentral part of a network (in a far outreaching network branch) and thus has a decentral function. The asset could be the center of a cluster (which is typical for any given cluster) and thus has a representative function for the cluster, or the asset has its own branch in a dendrogram, giving it an outlier function in the hierarchical cluster. Alternatively, an asset may influence most other assets in an influence network, in which case it has an influential function in the model.

Function of an asset in a network: In topological filter networks, like MSTs or PMFGs, the function of a node can be expressed as its central or decentral position in the network topology. Topological filtering starts with a fully connected network and deletes edges in order to meet topological requirements. These could be a network free of cycles (like loops of self-reference) like the MST or a network meeting a planarity condition so it can be embedded in a plane (like the PMFG). In directed networks like influence or causation networks, an asset's function is the impact on other assets. The direction of impact of one asset to another is represented as an edge with arrow and a respective weight for the edge. In both directed and undirected networks, an asset's function can be global with respect to the whole network structure or simply local when analyzing the topological network neighborhood of an asset. In directed networks like influence or dependency networks, causal activity relations of assets and the topological relations between the assets are analyzed with respect to their impact on neighboring assets and/or the whole network structure and topology, as we will show below.

Function of an asset in clustering: in a hierarchical cluster model the function of an asset corresponds to the position within the dendrogram. From a global perspective the deepness of the asset within the cluster structure corresponds to its function. A local neighborhood function of an asset relates to the dendrogram branch that the asset is located in. In a partitional cluster model an asset has a global function looking at its cluster membership. Its local function is the relations to the other assets in the same cluster. In centroid-based clustering, clusters are represented by a central point, which may not necessarily be a member of the data set. When the number of clusters is fixed to k, a procedure called k-means clustering gives a formal definition as an optimization problem: find the cluster centers and assign the objects to the nearest cluster center, such that the squared distances from the cluster are minimized. The cluster center or centroid is often synthetic point minimizing the distance (e.g. in 2D space) to all cluster members so in asset clustering it can be seen as a synthetic, referential asset. The asset with the lowest distance to the centroid is the real asset representative of cluster (“most typical asset of a cluster”). It can be evaluated if an asset is far away or near the cluster center.

Operatively Coupled: The term operatively coupled is used herein in its broadest sense and includes both direct connections and indirect connections. As a result, a processor operatively coupled to a tangible, non-transitory storage medium describes a processor that is directly coupled to that storage medium (e.g., a processor in a computer that directly accesses an internal memory of the computer through a bus) as well as a processor that is indirectly coupled to that storage medium (e.g., a processor that indirectly accesses that storage medium through intermediary devices, such as a router or the Internet). Similarly, a processor-based system that is operatively coupled to a database may access the information in the database directly (e.g., via a point-to-point connection) or indirectly (e.g., via a network server or a third party).

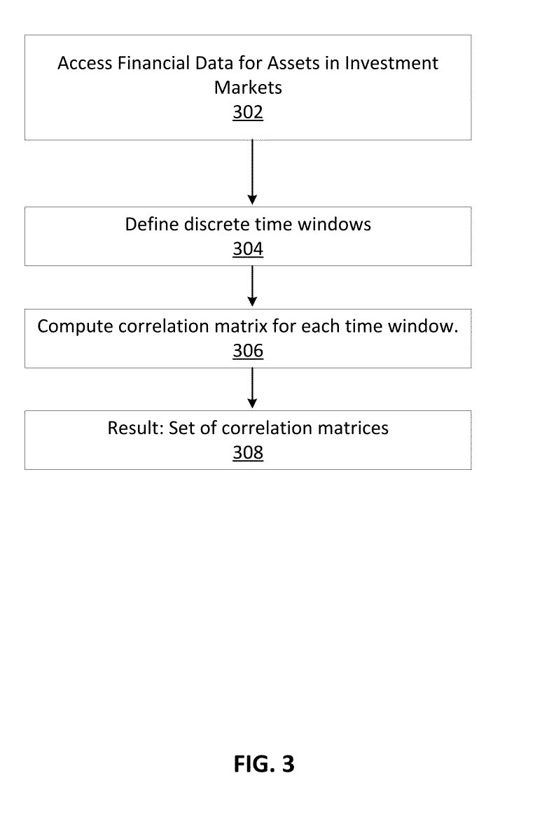

As discussed below in more detail, in some embodiments, a processor-based system analyzes financial data for a particular group of assets in order to alter an investment portfolio. FIGS. 3-8 illustrate, at a high level, exemplary operations that the system may execute when analyzing the financial data and/or altering the investment portfolio. Additional details regarding many of those operations are also provided in various examples below.

As shown in FIG. 3, in some embodiments, a system, such as, e.g., the computer 102 in FIG. 1, determines relationship characteristics for assets in selected investment markets. In particular, as shown in block 302, the system accesses financial data for those assets, e.g., via the Internet 106 and/or the server 102 shown in FIG. 1. For example, the system may access financial data for twenty five stocks in a stock market.

As shown in block 304, the system defines or identifies time windows over which the financial data is analyzed. For example, the system may identify a sequence of twenty months. The system then computes correlation matrices for each time window for the investment assets, as shown in block 306. In the example described above, the system computes twenty correlation matrices (one for each month), with each correlation matrix being a 25×25 matrix for the twenty five stocks whose financial data is analyzed by the system.

The entries of that matrix identify relationships between the financial data for each asset during that time period. For example, if daily returns were selected as the particular financial data point for analysis, then each entry in the matrix would identify the Pearson correlation of daily returns between the two stocks during this month. The result of this process, as shown in block 308 in FIG. 3, is a set of correlation matrices, e.g., the 20 matrices for the 20 months.

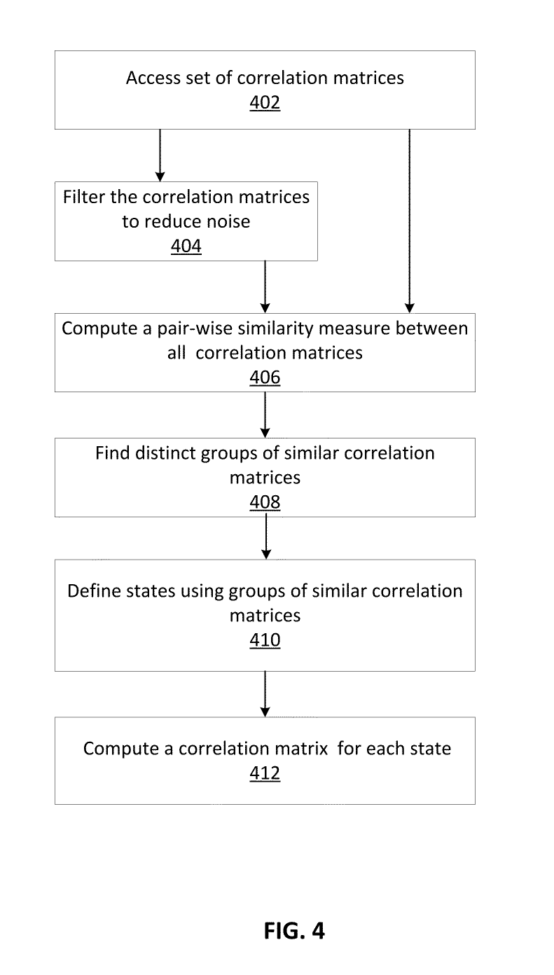

As shown in several of the Figures, for example, FIG. 4, the set of correlation matrices may be used in various ways in accordance with various embodiments of the present invention. For example, as shown in FIG. 4, the system accesses the correlation matrices, as shown in block 402, which may be stored in a storage medium. The system filters the correlation matrices to reduce noise, as shown in block 404.

As shown in block 406, the system computes a pair-wise similarity measure between each of the correlation matrices. As part of that operation, the system compares each matrix with every other matrix. Through those comparisons, the system is able to identify distinct groups of similar correlation matrices, as shown in block 406. In some embodiments, similar correlation matrices include entire correlation matrices while in other embodiments similar correlation matrices includes only portions (e.g., a particular subset of financial assets) of the correlation matrices exhibiting a particular relationship characteristic. As shown in block 410, similar correlation matrices are grouped together to define states and, as shown in block 412, the system computes a correlation matrix for each state: For each of the states, the financial data time series of each investment asset in all time periods belonging to this state are connected to build, for each asset, a financial data time series for this state. Then, using the financial data time series for this state, the correlation matrix for this state is computed. In our example, the system connects the vector of return time series of all the months that belong to one of the states to get the vector of return time series of the state, and then computes the correlation matrix for this vector of connected return time series. The dimension of the vectors and the dimension of the correlation matrices are the number of assets.

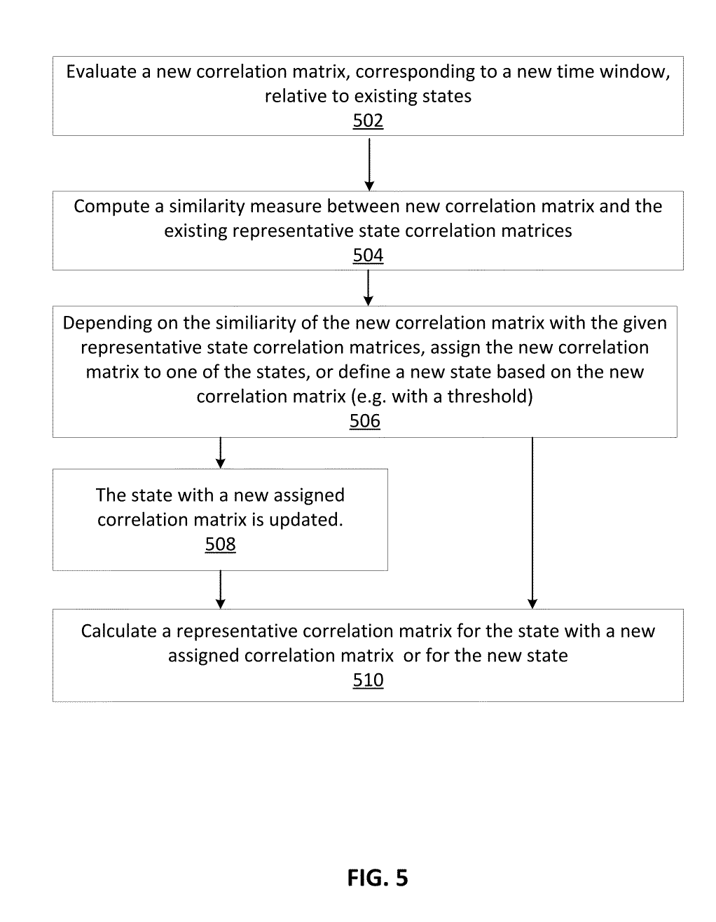

In some embodiments, and as shown in FIG. 5, the system can access financial data for a new time period and integrate that information into exiting states. In particular, and as shown in block 502, the system accesses financial data for a new time window (e.g., financial data during the 21^{st} month) and computes a new correlation matrix. As shown in block 504, the system computes a similarity measure between that new correlation matrix and the existing state correlation matrices. If the new correlation matrix is substantially similar to a correlation matrix for an existing state, the state is redefined to include that new time period and an updated correlation matrix for that state is computed. However, if the new correlation matrix is substantially different from any of the states, the system defines a new state containing that new time period. The determination of whether to add the new time period to an existing state or to form a new state may be made using, e.g., true cluster mining approaches to find the number of clusters (e.g., using the emergence of the cluster building process to intrinsically develop the proper number of clusters).

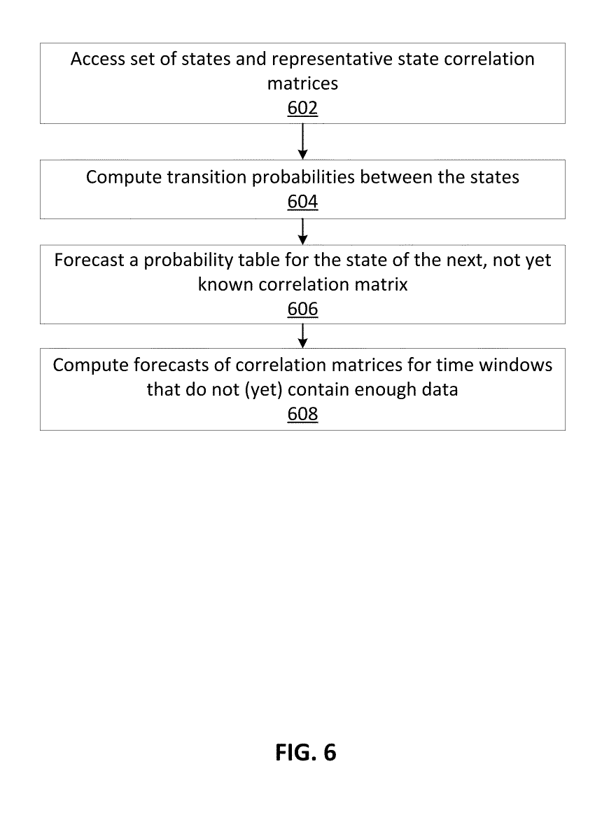

Referring now to FIG. 6, in some embodiments, the system accesses the state correlation matrices, as shown in block 602, and computes transition probabilities between the states, as shown in block 604. For example, the system counts the observed frequencies of each of the transitions from one state to another over the time period at issue. These transition probabilities can be stored in a probability table. The system may be configured to use these historical transition probabilities as estimations for the future transition probabilities from a particular state into another state, as shown in block 606. The probability table may be used, for example, to forecast financial data for time periods that are not yet complete, as shown in block 608. For example, the probability table may be used to predict financial data for an entire month when only two weeks of information is available. A simple implementation of such a forecast includes computing the expectation value of the financial data for the next unknown state, given the current state. For example, a forecast for the volatility of an investment portfolio can be calculated as the sum of the products of the historical values of this volatility in each of the states, multiplied with the transition probability from the current base state to this state. Alternatively, or additionally, the probability table may be used to alter investment portfolios to maximize performance for a predicted, future state. Another example would be to select one set of portfolio weights that maximizes the expectation value of portfolio performance among a selection of such sets. The expectation value of portfolio performance can be calculated as the sum of the products of the historical performances in each of the states, multiplied with the transition probability from the current base state to this state. As these performance expectation values could be computed for each of the sets of portfolio weights, the system could pick the set of weights with the highest performance expectation value.

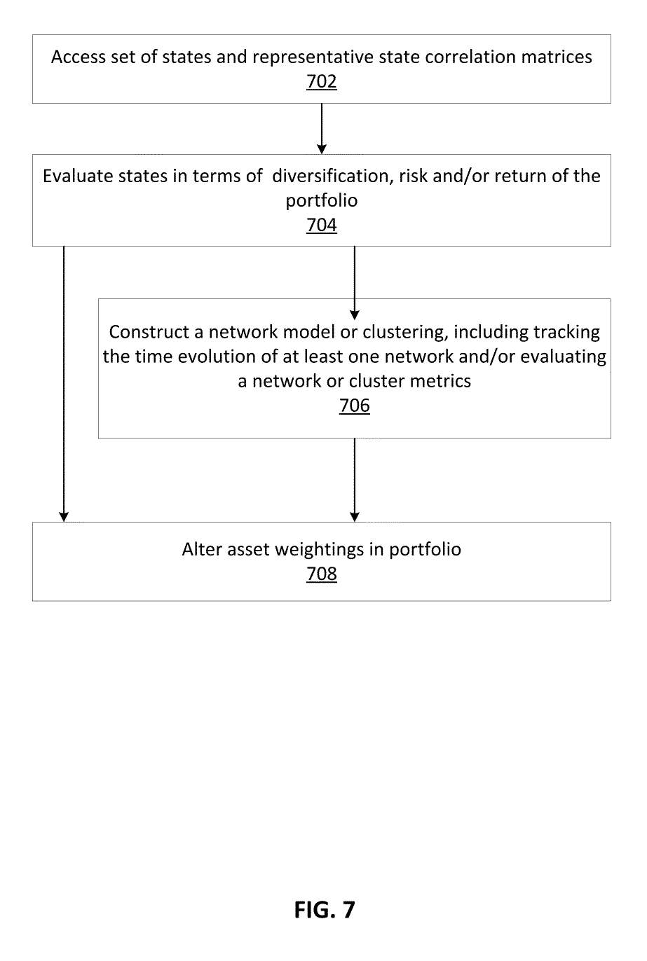

As shown in FIG. 7, in some embodiments, the system accesses the state information and correlation matrices, as shown in block 702, and analyzes the performance of an investment portfolio in one or more of the states, as shown in block 704. Based on that analysis, the system can alter the investment portfolio. For example, as shown in block 706, the system may construct a network model or cluster that represents each asset as a node and the relationship characteristics and the links between the nodes. Such a representation enables users to graphically alter an investment portfolio based on visual inspection of the representation. Alternatively, or in addition, the system alters weightings in the portfolio so that the performance of the portfolio in each state is congruous with investment goals.

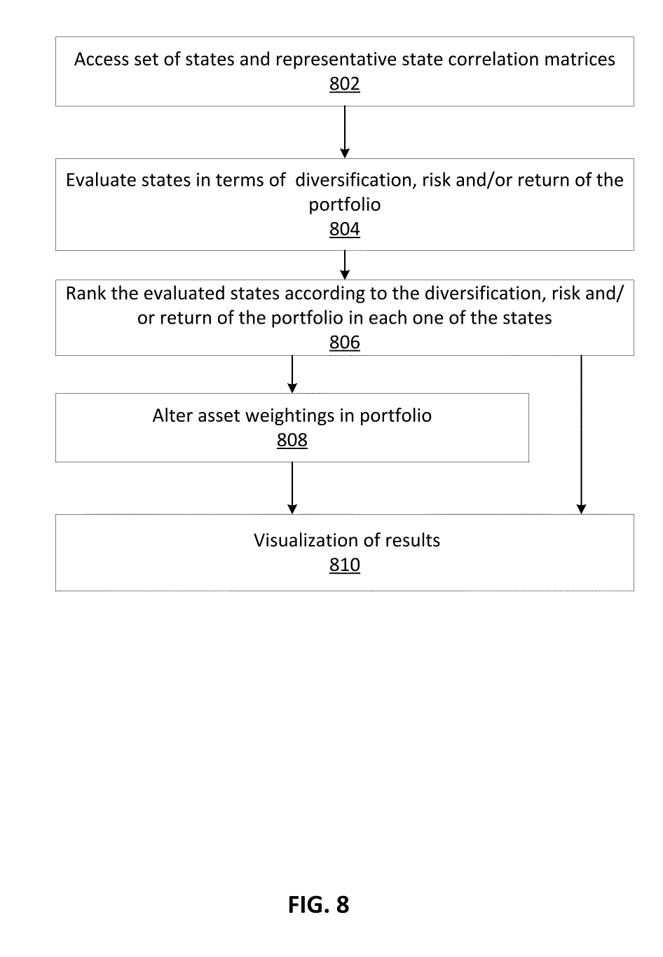

Referring now to FIG. 8, the system accesses the state information and correlation matrices, as shown in block 802, and evaluates the performance of a portfolio in each of those states, as shown in block 804. The system then ranks the states according to performance criteria, such as diversification, risk, returns, etc., as shown in block 806. That ranking information may be used to alter the portfolio itself, as show in block 808. For example, the system may decrease weightings of assets that significantly contribute to low-ranking states. Alternatively, or in addition, the state rankings as well as the portfolio performance may be visually conveyed using, e.g., a computer display, as shown in block 810.

To provide additional details regarding embodiments of the present invention, below are described various examples for several embodiments.

### Example 1

In the exemplary embodiments discussed below, a system (e.g., the computer 102 in FIG. 1) allocates assets in an investment portfolio in order to create a balanced portfolio with respect to crisis-induced correlation relationships. In particular, the system automatically identifies correlation relationships between assets that are related to crises. This information is used to modify the investment portfolio (e.g., by regulating the maximum downside risk of the portfolio allocation) in order to be prepared for future crises.

To begin, the system identifies particular assets in an investment market and accesses financial data for those assets, as noted in block 302 in FIG. 3. In this particular example, the system identifies twenty five liquid futures that cover a range of markets and asset classes and obtains the daily financial time series for those assets, in this example, the daily return information for those assets. In general, that financial data may span a predefined period of time, for example, several months or several years. For this example, the financial data for those assets spans fifteen years. The time series do not have to be continuous but may contain missing values, as usual data cleaning methods can be applied to improve the data set. An exemplary data cleaning method is the computation of correlations, where missing series values can be interpolated or omitted from the computations if there are enough remaining series entries.

The system also defines discrete time windows for the analysis, as noted in block 304 of FIG. 3. In this example, the system defines time windows that span one month, such that the fifteen year history of financial data can be broken into 180 discrete time periods (i.e., 180 months). Each time period is characterized by some aggregation or processing of the financial time series for the set of assets. In some embodiments, this is conducted under the absence of predetermined information on weights, limits and constraints (e.g. group or box constraints) regarding the set of assets. In other embodiments, additional information is used to further refine the particular time windows selected, such as the explicit weights/limits/constraints of the set of assets under consideration. Using that additional information opens further dimensions of characterization or evaluation of each time period. For example, the return of an investment portfolio could be calculated as the sum of the products of the weights and the returns of the individual assets. Another example would be portfolio risk measures like the volatility of the investment portfolio or the worst drawdown of the investment portfolio, which also use the weight information for the portfolio. The return time series of the investment portfolio can be computed as the sum of the products of the asset weights and the asset return time series. Using this investment portfolio time series, the portfolio volatility could be computed as standard deviation of the returns within this time series. If the weight information is not known, a predefined assumption for the weights could be made, for example, equal weights of 1/n for each of the n investment assets. The worst drawdown of an investment portfolio within a time period is defined as the minimum of the hypothetical set of returns that are defined from all possible initial investment dates to all later dates within this time period.

For each month, the system computes a symmetric correlation matrix, as noted in block 306 of FIG. 3. Thus, each month can be characterized by its correlation matrix. In this example, the system computes each correlation matrix using daily returns for each asset, resulting in 180 months that reflect a total history spanning fifteen years. For further clarification, an exemplary matrix for one month is shown below, in which the 25 liquid futures are noted as A-Y and the entries reflect the Pearson correlation in daily returns for the assets:

| | A | B | . . . | X | Y |
|---|---|---|---|---|---|
| A | 1 | Corr(B, A) | . . . | Corr(X, A) | Corr(Y, A) |
| B | Corr(A, B) | 1 | | Corr(X, B) | Corr(Y, B) |
| . . . | . . . | . . . | 1 | . . . | . . . |
| X | Corr(A, X) | Corr(B, X) | . . . | 1 | Corr(Y, X) |
| Y | Corr(A, Y) | Corr(B, Y) | . . . | Corr(X, Y) | 1 |

The system will compute 180 correlation matrices to create the set of correlation matrices referred to in block 308 of FIG. 3.

In the example above, the correlation matrix is created using daily return information. In other embodiments, the correlation matrix is created using moments and/or co-moment analysis of the asset return time series. In yet other embodiments, additional information sets (e.g., weights/limits/constraints) enable the system to determine correlation relationships within the time period for the set of assets under mathematical optimized procedures, like a rebalanced equal weighting or a mean-variance optimization on portfolio level. Nevertheless, a simple characterization for a time period is to compute the pair-wise correlation matrix of the asset returns within that time period.

The system then compares the plurality of correlation matrices in each of their pairwise combinations, as noted in block 406 of FIG. 4. In some embodiments, a pairwise comparison is realized by averaging the sum of squared differences of all correlation matrix entries. Note that this distance or dissimilarity measure is zero if there are two identical correlation matrices in the pairwise comparison. The result of this operation is a 180×180 symmetric matrix which characterizes the distances of all time periods to each other. For further clarification, an exemplary matrix is shown below, in which the 180 months are noted as 1-180 and the entries reflect the dissimilarity between two months:

| | 1 | 2 | . . . | 179 | 180 |
|---|---|---|---|---|---|
| 1 | 0 | Δ2, 1 | . . . | Δ179, 1 | Δ180, 1 |
| 2 | Δ1, 2 | 0 | | Δ179, 2 | Δ180, 2 |
| . . . | . . . | . . . | 0 | . . . | . . . |
| 179 | Δ1, 179 | Δ2, 179 | . . . | 0 | Δ180, 179 |
| 180 | Δ1, 180 | Δ2, 180 | . . . | Δ179, 180 | 0 |

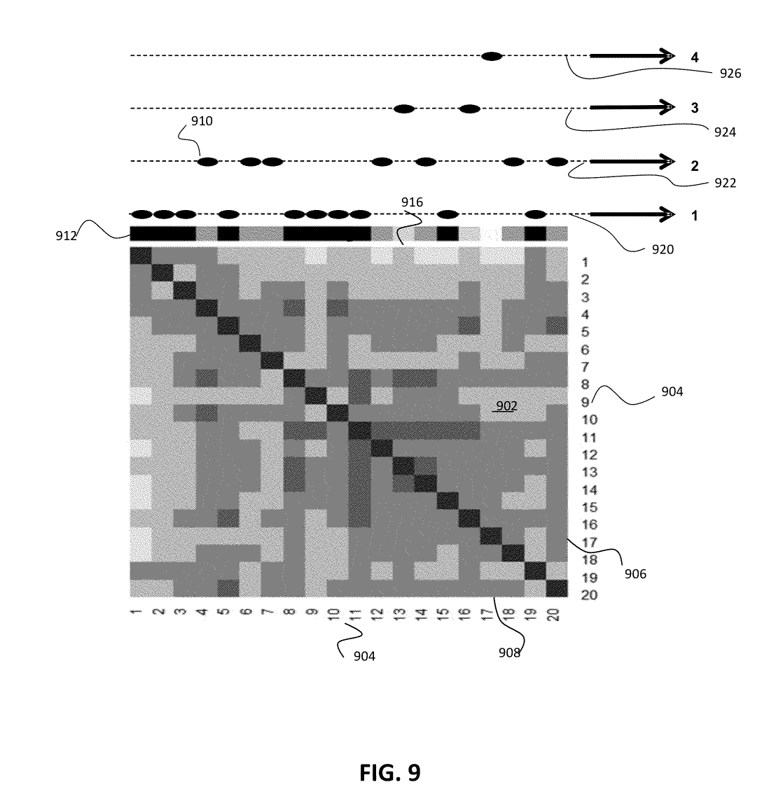

The system uses that pairwise comparison matrix, distance matrix or dissimilarity matrix to find distinct groups of similar correlation matrices, as noted in block 408 of FIG. 4. In this example, the system algorithmically groups various time periods into partitions or clusters, where all time periods within a cluster are very similar and, at the same time, are very dissimilar to the members of all other clusters. In a simple embodiment, the number of clusters (i.e., “k” clusters) that should be searched by the clustering algorithm is predefined. In this example, that number has been preset to four clusters (i.e., k=4). The algorithm of choice is the well-known k-means clustering which aims to partition n observations into k clusters in which each observation belongs to the cluster with the nearest mean, serving as a prototype of the cluster. As a result, the 180×180 matrix of time period dissimilarities can be clustered into k distinct partitional clusters. As shown in FIG. 9, an example of a smaller distance matrix of n=20 time periods can be understood as a heat map 902 in which different shades are used to indicate different relationship levels. Specifically, in FIG. 9 the darker shades designate a higher degree of similarity while lighter shades designate lower degrees of similarity. Colors or other indicia could also or alternatively be used. The numbers of the months 904 are shown on the right side 906 and on the bottom 908 of the heat map 902. A shaded bar 912, shown on the top 916 the heat map 902, identifies four different shades of grey that mark the attribution of a month to one of the four clusters. FIG. 9 also depicts dots, e.g., dot 910, located above the heat map 902 that indicate the membership of each of the 20 time periods to four clusters/states, which are differentiated by arrows 1-4 and the relative locations 920, 922, 924, and 926 of those arrows 1-4.

Each cluster represents a subset of time periods whose correlation matrices exhibit similar asset correlation structures. This in turn allows the system to define a state or market state using groups of similar correlation matrices, as noted in block 410 of FIG. 4. The plurality of clusters resembles a set of distinct market states and their timely occurrence. Subsequent time periods are often grouped in the same cluster, since the correlation structure typically does not change greatly from one time period to the next. However, there are instances where significant changes occur from one time period to the next in their assignment to a particular state, indicating that, during that span, there was a regime shift to another distinct correlation structure.

After defining the states, the system analyzes financial data for the assets in each state to compute a correlation matrix for each state, as noted in block 412 of FIG. 4. In our example, the system analyzes the daily (though not necessarily continuous or subsequent) return series of each state and computes a representative correlation matrix for each state.

Based on these subseries of each state, the system evaluates each state in terms of its risk profile for the investment assets. One way to evaluate the states is to assume an investment portfolio with equal capital weights among the assets or to use specific weights that characterize a known investment portfolio. Using the weights, the financial data series for the investment portfolio in each of the states can be calculated as the weighted sum of the respective financial data series of the individual investment assets in this state. Given the financial data series for the investment portfolio in a state, various performance measures for the investment portfolio in this state can be immediately calculated. In particular, the system can compute a historical Value-at-Risk (VaR) of the investment portfolio as an evaluation of each state, which is an exemplary technique for evaluating the states as noted in block 804 in FIG. 8. This exemplary technique uses a quantile-based downside risk measure of the portfolio of underlying equally weighted assets. The risk based evaluation of each state allows us to rank the states with respect to their state-conditional VaR, as noted in block 806 in FIG. 8 It is now straightforward to mark the state with the worst VaR. This state resembles a market phase where the underlying portfolio is at the most risk, for example, in times of crisis. From the former analysis it is also known what the specific correlation structure of this state looks like. Other examples for the evaluation of the state would be to compute the worst drawdown, volatility, or return for the investment portfolio. There is even the possibility to evaluate a state without any weight assumptions. This is done by analyzing the correlation structure (e.g. by network or clustering techniques), which provides a measure of the degree of diversification among the set of assets. Low diversification properties are generally related to higher risk.

With that information regarding the market states, the system can modify the weights of a portfolio in order to reduce the impact of crisis scenarios in the future. This may be done simply by analyzing the riskiest state's correlation structures and balancing the weights away from its unfavorable diversification properties, which are exemplary techniques for altering asset weighting in the portfolio as noted in block 808 of FIG. 8.

For example, the system can identify particular changes to the portfolio using a network model, which is one of the techniques noted in block 706 of FIG. 7. This is first done by modeling the riskiest state's correlation matrix as a correlation network and finding network central assets that are towards the center of the collective downward movement of prices. To achieve a goal of lower financial risk, the weights of these assets could be limited. In addition, the system can partition the correlation matrix for that state into distinct clusters and measure the realized returns of each cluster member. If there are clusters where nearly all member assets performed unfavorably, the system can limit their collective impact on the portfolio by reducing their weightings. In other words, the system seeks to identify single assets or groups of assets that strongly impact the collective behavior of the portfolio in a way that gives the state its high risk ranking, and then reduces the weights of these assets relative to the weights of all the other assets.

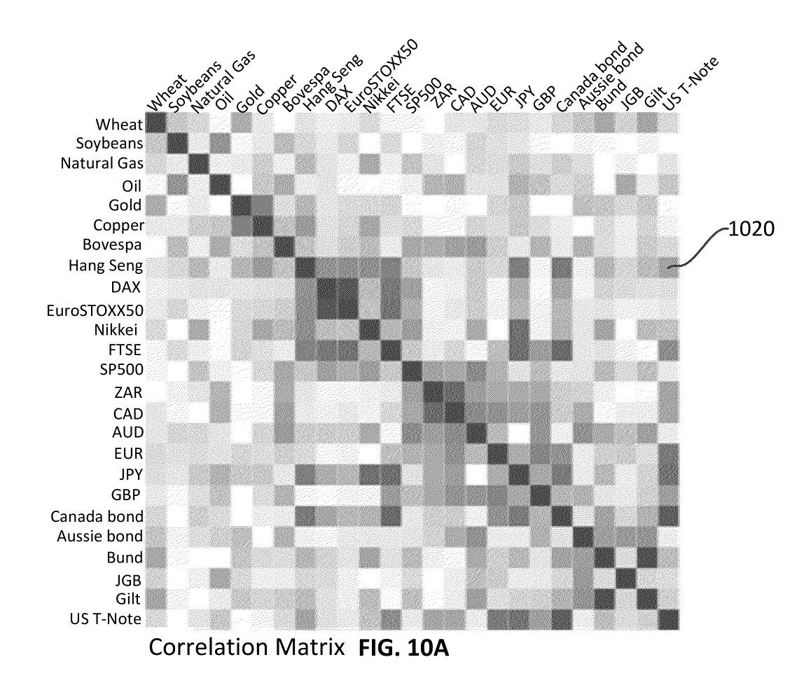

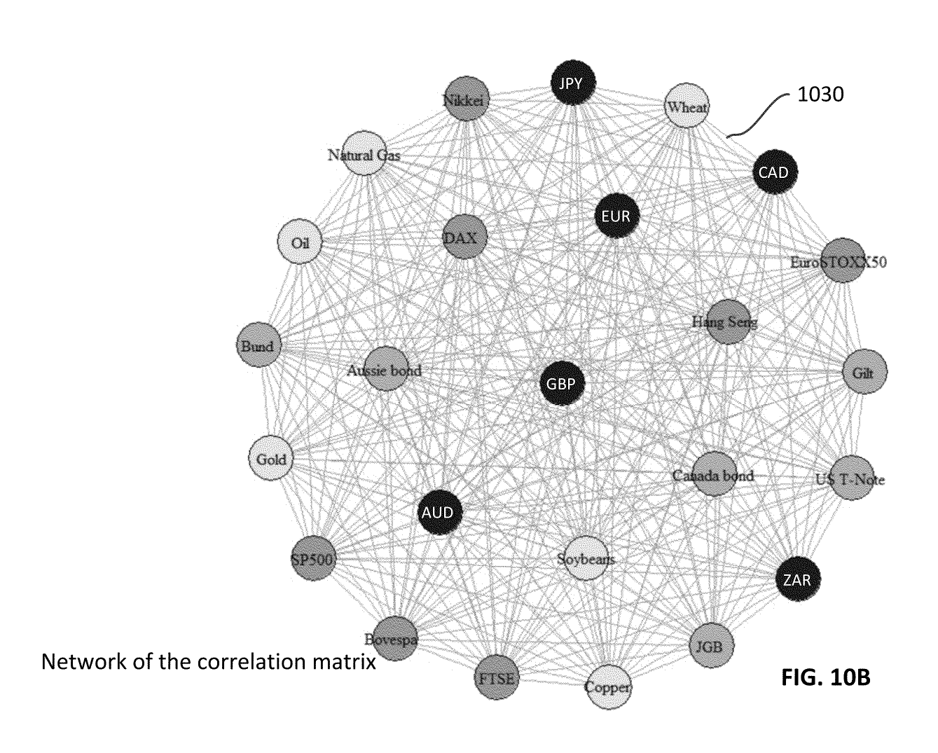

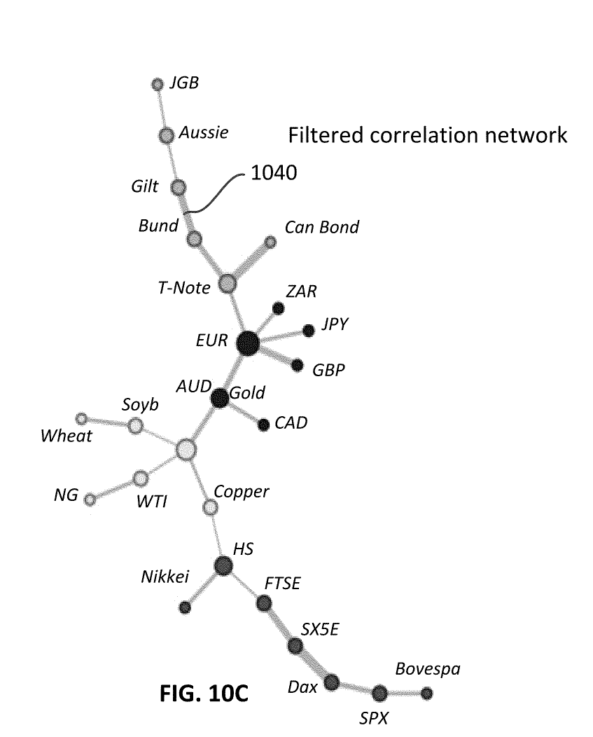

In some embodiments, the correlation network is constructed by transforming the state's correlation matrix into a correlation distance matrix. For example, a pairwise correlation coefficient “con” is transformed to a correlation distance “d” by the formula d=\sqrt{2(1−corr)}, which resembles a metric. This distance matrix is then transformed to a network model such that each asset is represented by a node and each pairwise correlation distance matrix entry is represented by a link. The system then applies a link reduction of the network by using the Minimum-Spanning-Tree (MST) algorithm. This process is illustrated in FIG. 10, which illustrates graphical representations of a state correlation matrix 1020 as it is transformed into a correlation network 1030 and finally into a filtered correlation network 1040.

With the network model in place, the system measures the centrality and/or peripherality of each asset in the network. This measure is based on the topological properties of the correlation network. The more central an asset, the more integrated it is in the collective relationships of assets and the less it contributes to diversification (which consequently increases risk). For an all-encompassing risk analysis, it is straightforward to also account for the risk weight in combination with network or cluster centrality. For example, the riskiness contribution of an asset can be its centrality multiplied by its risk (contribution).

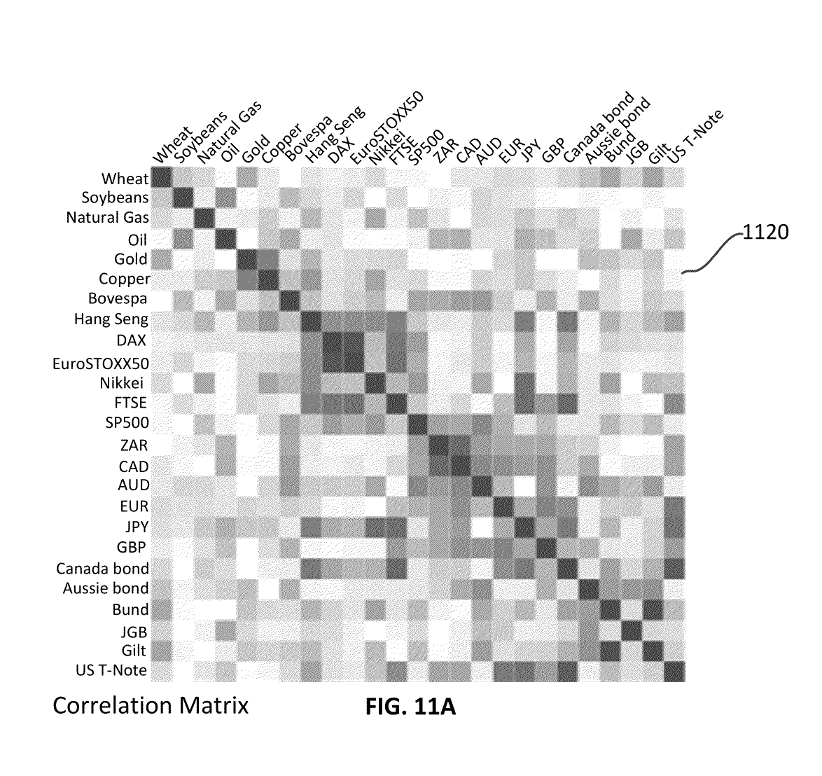

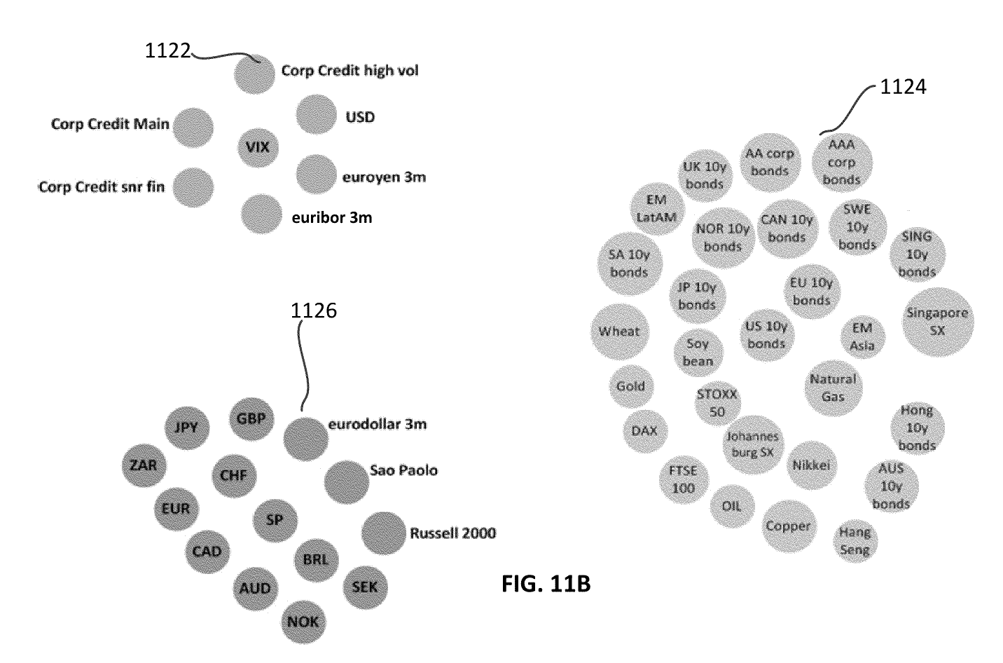

To determine a more optimal distribution of assets, the partitional correlation clusters are generated again by a k-means algorithm to find the optimal distribution of assets on the k clusters. Optimality is expressed in terms of strong cluster separation and within-cluster homogeneity. For example, as shown in FIG. 11, the assets of a correlation matrix 1120 for the state are separated into three correlation clusters 1122, 1124, and 1126. In this example, the three clusters 1122, 1124, and 1126 were generated by testing different partitions of the assets and computing the inter- and intra-cluster distance. To compute the intra-cluster distances, the distances of all assets in one cluster are averaged. Also, the average distances of the assets in two different clusters are computed. Doing these computations for all pairwise cluster comparisons and averaging them will result in the inter-cluster distance. The ratio of the average intra-cluster distance and average inter-cluster distance should be maximized in order to get well separated meaningful clusters. Another approach to separating the clusters is the silhouette index. Based on the pairwise distance matrix of assets, this technique computes, for each asset, if it is similar to the other assets in the same cluster or if it would better fit into another cluster. Averaging this measurement over all assets will result an evaluation how many assets are put into the correct cluster structure. The higher the value the better the clustering result.

In order to reduce risk, both the most central assets and the assets of the low-performing clusters should be reduced in terms of their weights and more weight could be allocated to the peripheral assets and to the high-performing clusters. This reweighting can be based on a set of rules and objectives to reduce the drifting away of the portfolio from the initial equal weighting. The weighting can be controlled by the tracking error of the initial portfolio relative to the equal weighted benchmark during the optimization, so the reallocations away from the equal weight portfolio are only moderate due to the tracking error controlling. The tracking error between the initial portfolio and the optimized portfolio is defined as the standard deviation of the difference between the two return time series of the two portfolios. Another control mechanism is the effective reduction of portfolio VaR: the weights are only shifted away from the weights of the initial portfolio as long as the absolute value of the VaR is reduced below a certain threshold. The former analyses can also be extended to a long/short portfolio: those assets that have so far been reduced in weight because of their lack of diversification or risk reduction could also be sold short. That would result in a portfolio weight vector that could also have negative entries.

The outcome of the steps discussed above is an asset allocation within the investment portfolio that is balanced with respect to typical crisis patterns. It is expected that the asset relationships exhibit a similar pattern in a future crisis. However, this future crisis won't harm the asset collection in the usual manner, as the weights of the assets are adapted in a way to maintain diversification properties—even at periods of market stress. The portfolio manager and/or the system are thus able to manage and mitigate asset allocation risk and to report and explain the mechanics and outcomes of this approach.

### Example 2

According to other exemplary embodiments, the system uses particular techniques to increase the future risk-adjusted performance of a group of assets, e.g., a portfolio of German equities. Several techniques used in this example are very similar to techniques described in the previous example, but in this use case the system refines those techniques and integrates them into a holistic investment process that enables a portfolio manager to build up an investment fund.

In this example, the assets of the portfolio are selected from several dozen liquid stocks listed on a major German stock exchange. The investment constraints are defined as boxes for each stock with weight limits ranging from 0% to 5%. Also, it is a long-only, fully invested portfolio: all entries of the portfolio weight vector are positive or zero, and they sum up to the total leverage of 100%. A leverage number of 100% reflects a fully invested portfolio. The objective in this portfolio optimization program is to optimize the expected portfolio return per unit of a coherent downside portfolio risk measure under consideration of the constraints. A different approach would be to build a combination of long and short weights. An example is the so-called “130/30” portfolio where the sum of the weights of the long investments is 130% and the sum of the weights of the short investments 30%, netting to a total delta exposure of 100% but with a leverage of 160%.

The investment process is structured in the following way: First, the system generates a correlation network from the set of stocks and identifies a subset of decentral stocks with favorable prospective performance ratios. Next, the system formulates a portfolio optimization program based on the subset of selected stocks. The optimization has the objective to maximize the ratio of expected returns over CVaR (Conditional VaR) at a 95% confidence level within the space of feasible portfolios which meet the investment constraints. The CVaR also accounts for the likelihood (at a specific confidence level) that a loss will be worse than the VaR. The CVaR is defined as the expectation value of the losses for the portfolio values below the VaR. This optimization program can be approximated by a linearization so that the finding of a global optimum within a convergence time can be better ensured.

The mean-CVaR optimization is extended by additional group constraints limiting the weights of some groups of stocks. The groups could be industries or sectors and the group constraints reduce the maximum industry weighting or elevate it above a minimum value. Another way of defining the sectors is a partitional clustering that clusters the stocks with respect to their correlation properties. Since each cluster is driven by a specific loading of a set of unobservable factors, it is favorable for the diversification of the portfolio to distribute the stock weights equally across the clusters. Based on a given asset weight vector the cluster concentration can be measured by a concentration measure like the Gini coefficient: an equal spread of weights among the clusters results in a Gini coefficient of 0 The maximization of the Gini coefficient can be added to the portfolio optimization program as a constraint as a minimum Gini or as an additional objective.

Thus, the resulting investment process begins with a selection of stocks from a larger group of investment assets that exhibit good diversification and performance properties. This subset of stocks is then optimized in order to meet the investment constraints and to improve diversification across asset clusters. The resulting portfolio simulations have very low risk, good diversification properties and high performance. The process can be repeated to rebalance the portfolio for fresh data. If there are frequent rebalancings, turnover is low since the networks and the clusterings remain stable. That stability is created because the clusterings address the assets' backbone relationships, which do not change greatly over time. Also, the portfolio has an individual trajectory that decouples it from other benchmarks and markets, which contributes to market diversification.

An extension of this example is the preprocessing of the input data to generate the network and the clusterings discussed above. This preprocessing incorporates the state identification techniques discussed above, e.g., with respect to example 1. It is possible to weight the input time series from the states. The weighted return time series are then taken to estimate a correlation matrix, which can then be analyzed with a network model or clustering. The weights could, for example, correspond to the riskiness of the states: the more risky a state is the higher the weight. The resulting correlation matrix estimation thus contains emphatic information for those states that were indicated as risky. The resulting correlation matrix then incorporates the information of several risky states so optimizing a portfolio with respect to this resulting correlation is conservative in terms of risk, since all possible states with high risk are considered in the resulting matrix of weighted return time series. The weight vector attributes more weight on the risky periods so that the resulting networks and clusters represent the relationships during times of stress and therefore improve portfolio diversification and portfolio risk reduction.

Two further algorithmic adaptions improve the outcome of the process: one addresses the estimation noise of the input time series and the other improves the finding of states. The first adaptation occurs by transforming the time series' correlation matrices into correlation networks like MSTs. Since only the highest and thus most significant correlations are chosen for the network topology, this step has a noise filtering function, as noted in block 404 of FIG. 4. The MSTs of the time periods are then represented as dendrograms that are in turn used for the pairwise comparison of all combinations of time periods. A comparison of two dendrograms can be done by standard procedures like computing the cophenetic correlation matrix. The second adaptation addresses the ideal number of states (“k”) to be chosen by the clustering algorithm. One particular technique to identify “k” is to evaluate the clustering quality with standard measures on a range of values for k. The k with the highest resulting clustering quality is chosen.

As discussed above, the system computes correlation matrices for a plurality of time periods and then compares the correlation matrices for the time periods in a pair-wise fashion. In some embodiments, this step quantifies a similarity/proximity of the time periods. The more dissimilar the time periods are, the large the dissimilarity. Dissimilarity is zero when the characteristics of identical time periods are compared. There are several ways to compare the characteristics of two time periods. Below are discussed five exemplary techniques for comparisons, which can be used in isolation or in combination with one another:

First, the system computes the realized return of each asset in the set and constructs an asset return vector. Two asset return vectors can be compared in terms of a distance measure like Euclidean or Angular.

Second, the system computes a realized asset volatility vector for each of the two time periods and uses the distance measures discussed in the paragraph above.

Third, the system computes a correlation matrix for each of the two time periods and computes the squared sum of absolute differences of each matrix entry in the upper or lower diagonal of the matrices as a distance measure, as discussed above. As one of ordinary skill will readily appreciate, a variety of techniques may be used to estimate the correlations.

Fourth, the system estimates a parametric model for each of the two time periods and then compares the parameters of the model corresponding to the two time periods. For example, the system could use a model with parameters controlling the clustering of volatility, like the model family based on GARCH (generalized autoregressive conditional heteroscedasticity), which is a technique that will be readily understood by one of skill in the art. Econometric models like GARCH are readily available in a general purpose software tools like R with the rugarch package or the econometrics toolbox of MATLAB®.

Fifth, the system computes a correlation matrix for each of the two time windows. However, the correlation coefficient of a pair of asset returns cannot be used as a distance because it does not fulfil the axioms that form a metric. A real metric can be designed using a function of the correlation coefficient. It can be rigorously determined by a transformation of the correlation coefficient so that the distance between variables is directly proportional to the correlation between them. Then the system transforms the matrices to a hierarchical clustering and/or a partitional clustering and/or a network.

For example, two hierarchical clusterings can be compared on the basis of their cophenetic matrices. Hierarchical clustering is a collection of procedures for organizing objects into a nested sequence of partitions on the basis of the similarity or respectively dissimilarity among the objects. It is the fitting of a high dimensional space into a tree-like structure that is depicted in dendrograms. The dissimilarity between objects is measured by a distance matrix D whose components dᵢⱼ resemble the distance between two points xᵢ and xⱼ. The hierarchical clustering procedure is a two-stage process: choice of a distance measure and choice of the cluster algorithm, in which both choices together define the whole clustering outcome. Distance measures of asset return time series focus on the dissimilarity between the synchronous time evolutions of a pair of assets. The matrix of pairwise distances will be the input of the hierarchical cluster algorithm that uses some linkage rule to determine a hierarchical structure. The choice of clustering procedure, also in combination with the distance measure of assets, has to be carefully made as it is a critical part of some embodiments.

For another example, the system may use agglomerative hierarchical clustering algorithms to produce nested series of partitions based on merging criterions. Each partition is nested into the next partition of the sequence. After a distance measure has been defined and a distance matrix has been calculated, the hierarchical clustering can be carried out by a suitable clustering algorithm. The clustering algorithm specifies how the distance matrix is processed in order to merge two elements/clusters until a single cluster containing all elements is created.

In hierarchical clustering a bijection is defined between a rooted, binary, ranked, indexed tree, called a dendrogram, and a set of ultrametric distances). The “strong triangular inequality” or ultrametric inequality is d(x,z)≦max{d(x,y),d(y,z)} for any triplet of points x, y, z. The structure that was imposed on the distance matrix by the clustering algorithm is captured in the cophenetic/ultrametric matrix. The cophenetic matrix records the distance value at which a clustering is formed. Or, more precisely, the cophenetic proximity matrix indicates at which level (distance) two objects first appear in the same cluster. It therefore usually contains many ties. It has perfect hierarchical structure. The higher the degree of agreement between the cophenetic matrix and the distance matrix, the better the hierarchical structure fits the data. The goal of a clustering algorithm is to find a perfect hierarchical structure that is as close to the distance matrix as possible. This insight will play a crucial role when determining the Cophenetic Correlation Coefficient (CPCC) that helps determine the quality of the clustering. As clustering algorithms will always find a clustering structure, one has to determine to which extent the clustering could have evolved from a random structure or is itself random). The CPCC is defined as

$$CPCC = \frac{{\sum }_{i < j} ( {d}_{ij} - \overline{d} ) ( {c}_{ij} - \overline{c} )}{\sqrt{[ {\sum }_{i < j} {( {d}_{ij} - \overline{d} )}^{2} ] [ {\sum }_{i < j} {( {c}_{ij} - \overline{c} )}^{2} ]}}$$

letting d̅ be the average of the dᵢⱼ and letting c̅ be the average of the cᵢⱼ.

At least four clustering algorithms may be used in this analysis: single-linkage, average-linkage, complete-linkage and Ward's method. All of these algorithms are readily available in a standard software tool like R or SAS or the statistics toolbox of MATLAB®. In R these are even part of the base installation. The single-linkage and complete-linkage algorithms follow two basic concepts that are oftentimes used to derive different algorithms. The idea behind single-linkage is to form groups of elements that have the smallest distance to each other (i.e., nearest neighboring clustering). This oftentimes leads to large groups/chaining. The complete-linkage algorithm tries to avoid those large groups by considering the largest distances between elements. It is thus called the farthest neighbor clustering. The average-linkage algorithm is a compromise between the single-linkage and complete-linkage algorithm. Ward's method joins elements/clusters that do not increase a given measure of heterogeneity too much, and thus tries to create groups within clusters that are as homogenous as possible. It becomes clear, however, that the fundamental difference in many hierarchical clustering algorithms is the definition of “closest clusters.” A more detailed description of the preferred clustering algorithms will shed some light on their basic idea and understanding of how a similarity measure is made.

In executing those algorithms, the system may use single-linkage clusters that are characterized by maximally connected subgraphs. The algorithm clusters the elements that are nearest to each other first, and thus is often referred to as the “nearest neighbor” or “minimum algorithm.” Its basic idea can also be used to construct minimal spanning trees to which the single-linkage algorithm is closely related, as will be shown later. The single-linkage takes the minimum distance between two elements/clusters of the current (updated) distance matrix to merge the next elements/clusters. It can thus be described as pseudo code in the following form:

Compute proximity matrix

repeat
Merge clusters for which the distance d(Cᵢ,Cⱼ)=min_{xεC}_{ᵢ}_{,yεC}_{ⱼ}d(x,y)
Update proximity matrix to reflect changes until One cluster remains,
   where Cᵢ and Cⱼ are intermediate clusters i and j in the merging process, and where x and y are the elements of clusters Cᵢ and Cⱼ. The complete-linkage clusters are more restrictive with respect to the pairs of clusters that are merged in a round. All pairs of objects are related before the cluster is formed. The minimum of those distances indicates which clusters or objects to merge next. It is thus less vulnerable with respect to noise and outliers. However, it can break large clusters and lead to globular shapes. It is furthermore usually more compact than the single-linkage algorithm. For many practical applications, the complete-link clustering provided better results than single-linkage. The clustering algorithm is in its design very similar to the single linkage, with the exception of the merging operation. The pseudo code for the complete-linkage is:

Compute proximity matrix

repeat
Merge clusters for which the distance d(Cᵢ,Cⱼ)=max_{xεC}_{ᵢ}_{,yεC}_{ⱼ}d(x,y) Update proximity matrix to reflect changes

until One cluster remains

The average-linkage clustering algorithm is a combination between the complete-link and single-link as it does not take the minimum or maximum distance between pairs of clusters but the group average. The distance used to determine, which clusters are to be merged next is thus defined as:

$$d ( {C}_{i} , {C}_{j} ) = \frac{{\sum }_{x ∈ {C}_{i} , y ∈ {C}_{j}} d ( x , y )}{\vert {C}_{i} \vert \vert {C}_{j} \vert}$$

The clustering algorithm is the same for the average linkage as for single linkage or complete linkage with the only difference of the definition of “most similar pair of clusters”.

Whereas single-linkage, complete-linkage and average-linkage can be classified as graph-based clustering algorithms, Ward's method has a prototype-based view in which the clusters are represented by a centroid. For this reason, the proximity between clusters is usually defined as the distance between cluster centroids. Whereas in the clustering approaches discussed earlier, the “farthest”, “closest”, etc. distances between clusters or elements was used to derive the next merging operation, in Ward's method the increase of the “sum of the squares error” (SSE) is determined. The SSE is the sum of errors of every data point. The error of every data point x is its distance from its closest centroid cᵢ for each of the K clusters. The SSE can be calculated as:

SSE=Σᵢ₌₁^{K}Σ_{xεC}_{ᵢ}dist(cᵢ,x)²

The centroid (mean) of any cluster i is defined as:

$${c}_{i} = \frac{1}{{m}_{i}} {\sum }_{x ∈ {C}_{i}} x$$

Just like the k-means (partitioning clustering algorithm), Ward's method tries to minimize the squared errors from the mean (objective function is similar). However, it differs in the way that Ward's method is a hierarchical algorithm, where elements are merged together.

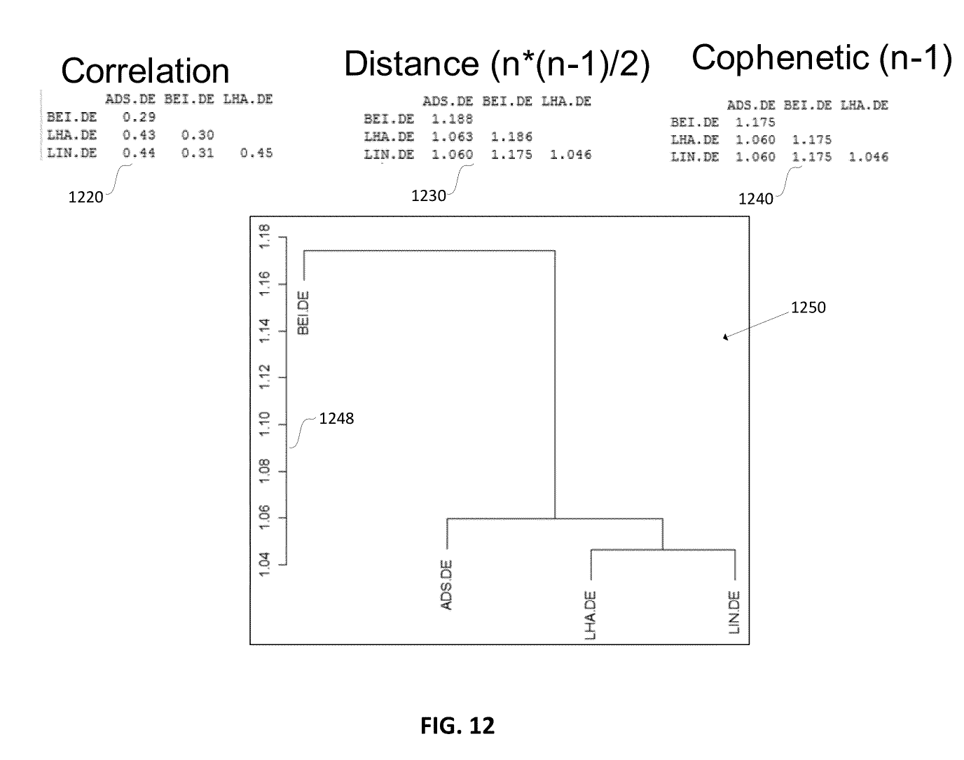

For additional clarity, FIG. 12 illustrates the transformation of a correlation matrix into an ultrametric or cophenetic matrix. In particular, a 3×3 lower triangle of a 4×4 correlation matrix 1220 is made using financial information for four German stocks. The return correlation matrix 1220 is transformed to a distance matrix 1230, which is then transformed into the ultrametric or cophenetic matrix 1240 by the single linkage hierarchical clustering. The height 1248 of the dendrogram 1250 indicates the distances at which clusters were agglomeratively merged together. In those transformations, the ultrametric distance C resulting from the single linkage method is such that cᵢⱼ≦dᵢⱼ always. It is also unique with the exception of ties. It is also termed the subdominant or maximal inferior ultrametric. The distance matrix of a correlation matrix of rank n contains also n*(n−1)/2 entries in the lower triangle, whereas the cophenetic matrix contains only (n−1) different entries.

In some embodiments, two partitional clusterings can be compared by the (corrected) Rand index, which is a measure of the amount of consensus in two partitional clusterings, while in other embodiments two networks can be compared by exploiting their topological properties. For example, the amount of edges/links that coincide in two networks can be measured as well as the amount of missing links in one or the other network.

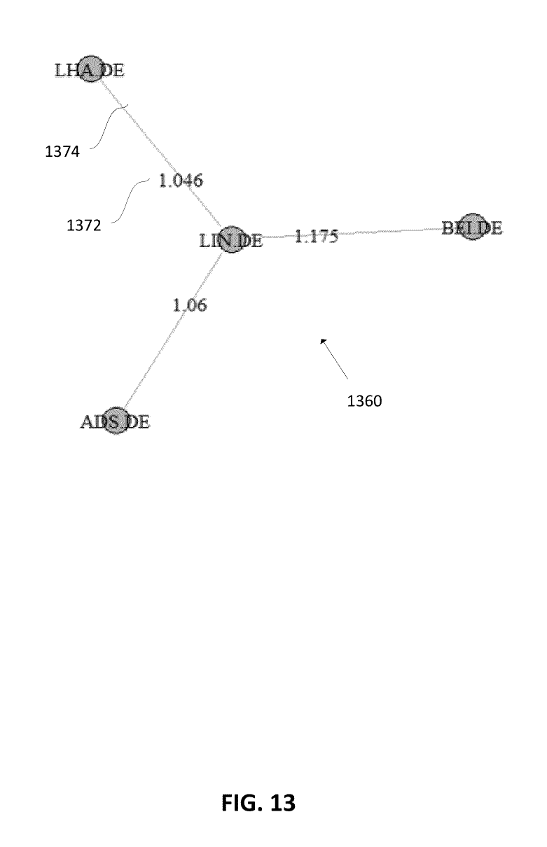

The clustering procedure and the network construction exhibit certain filtering properties for the often noisy input data, which can be used in step 404 in FIG. 4. For example, the single linkage hierarchical clustering and the MST/PMFG (Planar Maximally Filtered Graph) construction choose a subset of the entries of a correlation matrix that is higher on average than the average of the matrix entries. This is shown by the illustrations in FIG. 13A. In particular, FIG. 13A depicts a filtered network diagram 1370 generated using the clustering and network construction techniques discussed above using on the matrices and clustering results illustrated in FIG. 12. In particular, the matrix used to generate the illustrations in FIG. 13A is the unfiltered distance matrix 1230. The MST 1370 corresponds to the dendrogram 1250, which illustrates the output of the single linkage hierarchical clustering. Also, the numbers 1372 on the network links 1374 identify the respective pairwise distances. It can be seen that the highest distance value 1.188 of the matrix does not occur. This in turn means that the average correlation of the network edges is lower than the average correlation of the correlation matrix.

As a result of this filtering process, the higher and thus more significant matrix entries are chosen. An advantage of using correlation networks for transforming two correlation matrices corresponding to the two time windows is that building correlation networks out of correlation matrices does not require the correlation matrices to be regular, as no Cholesky decomposition, inversion or principal component decomposition has to be performed. Regularity requirements are often violated for correlation matrices of financial data due to missing data or too short time windows in relation to the rank of the matrices.

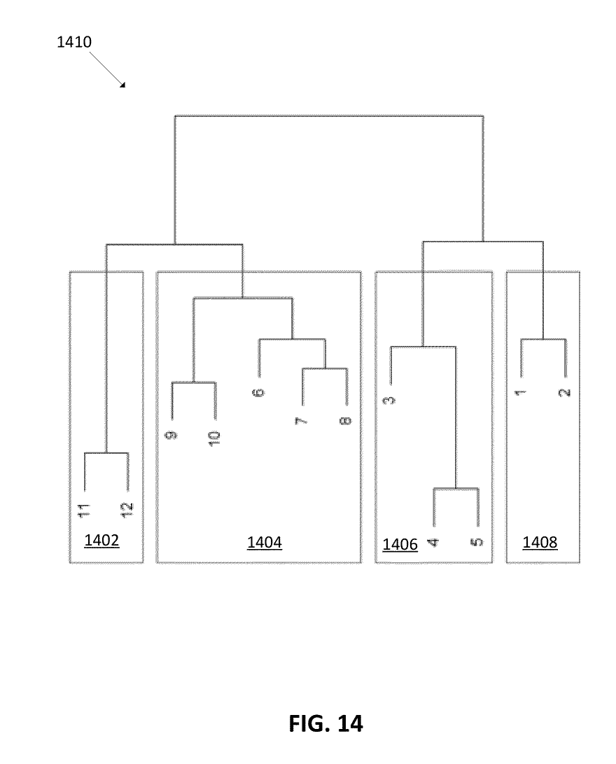

The quality/significance of the clustering procedures or the network constructions can be evaluated by several measures and procedures. This, in turn, can be used for finding the optimal number of clusters for the partitional clustering. This is commonly done by a cluster quality measures like the Average Silhouette Width or the Dunn Index which is computed for a series of different cluster numbers (“k”). The k with the optimal value of the clustering quality criterion is chosen. Another way is to plot the clustering quality for each k and finding a strong bend in the line where the additional value of fewer or more clusters strongly decreases (elbow or Mojena criterion). There are similar techniques for transforming hierarchical clusterings into partitional clusterings by cutting the dendrogram at certain levels, as shown in FIG. 14, with a cutting point to get k=4 clusters (each box 1402, 1404, 1406, 1408 denotes one of the four clusters of the dendrogram 1410).

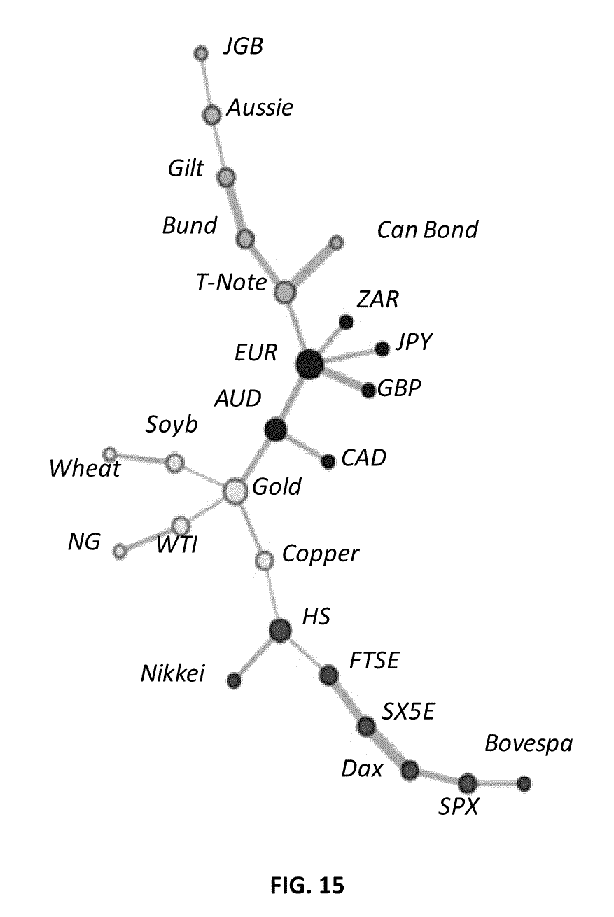

There are similar techniques for transforming financial networks into partitional clusterings by cutting the network at certain edges. For example, network communities (i.e., dense regions of the network) can be defined in a hierarchical or partitional or overlapping/non-overlapping way. Networks can be cut at certain points to find clusters. Optimal cutting points in dendrograms can be found to find an upper and lower hierarchical structure or partitional clusters. In FIG. 15 there is an example of a minimal spanning tree of 25 different assets. The four shades in that figure represent four different asset classes covered by the 25 assets. The tree is based on the correlation matrix and a transformation to a correlation distance. Color could also be used to designate different asset classes.

Also, there are techniques to reduce the impact of initialization of the procedures. For example, there can be pre-optimized starting values for the cluster centers or centroids in the well-known k-means clustering procedure. Additionally, there are true cluster mining approaches to find the number of clusters (using the emergence of the cluster building process to intrinsically develop the proper number of clusters).

Having computed all pairwise dissimilarities of the time periods, it is now possible to analyze and structure this matrix, for example, for finding distinct groups/clusters of similar time periods, as noted in block 408 in FIG. 4. All procedures like hierarchical/partitional clustering and/or network constructions that were already introduced can be used here. In other words, the matrix of time period dissimilarities and the matrix of asset dissimilarities can be treated with the same methods, keeping in mind that the former was constructed on the plurality of the latter.

An example is to use a partitional clustering to the matrix of time period dissimilarities. The time periods are hereby grouped according to their similarity: each cluster contains very similar time periods in terms of the time periods' characteristics. These clusters can be interpreted as regimes or states of very typical and distinct collections of time periods.

As outlined before, having generated the distance matrix of time periods, it is not only possible to apply a partitional clustering model but also (or alternatively) a hierarchical clustering or a network model. For example, splitting a hierarchical dendrogram, which is based on the distance matrix of time periods, at the highest point will result in two cluster branches, each with a hierarchical substructure in it. Cutting those sub-branches again and again will result in a higher resolution of the hierarchical substructure of the time periods. This provides insight into how the time periods are nested into branches on different resolution levels. A network of time periods enables the system to find communities of time periods. By all three methods, namely partitional clustering, hierarchical clustering, and network models, it is possible to detect outlying, and thus very unusual, time periods with respect to the assets' relationship characteristics. For example, an asset with its own direct connection to the root level in a dendrogram is an outlier. Or in a network, a very decentral node is outlying. The further analysis of an asset relationship matrix by means of network or cluster models does not necessarily require a matrix representing a state but it could be any time period (sequential or non-sequential) represented by an asset relationship matrix. Also, it should be noted that there are two singular situations: 1) there is just one input time period and thus one state or 2) there are as many states as input time periods.

Hierarchical clustering algorithms recursively find nested clusters either in an agglomerative mode (starting with each data point in its own cluster and merging the most similar pair of clusters successively to form a cluster hierarchy) or in a divisive (top-down) mode (starting with all the data points in one cluster and recursively dividing each cluster into smaller clusters). This clustering can identify “mother states” as well as “child states” or “descendant states”. Also, both hierarchical and partitional clusterings as well as a network structure of the time periods can for example be used to detect outlying and thus very unusual time periods or groups of them.

As outlined before, in some of these embodiments, there are two singularities with respect to the numbers of time periods and clusters: there could be just a single time period as an input to the clustering or the number of clusters k could have been chosen according to their admissible maximum (e.g., the number of time periods). All analyses/applications described with their claims covered can be used also for these singular situations.

The data used to generate the states do not necessarily have to be financial time series for traditional investment assets but could be time series for macroeconomic indices such as GDP, unemployment rate, inflation, or volume of money in circulation. In some embodiments, the financial time series could be index or spread time series or risk factor time series, as well as return time series on which basis a manager's performance can be derived (i.e., his track record). In addition, the financial time series could be time series coming from financial derivatives, like option price time series or time series of the implied volatility from an option. Finally, the financial time series could be a time series generated by statistical procedures like bootstrapping, sampling or shuffling or it could be the return realizations of randomly drawn weight vectors (i.e., a random portfolio), eventually being constrained by a weight limit per asset, for example. An exemplary application would be the derivation of states from the relationships of macroeconomic variables: each state resembles a distinct constellation of a macro-economy. As a result, the system is able to analyze the performance/risk of a portfolio of traditional investment assets in the different macro-economic states.

Having found several distinct states by a clustering procedure, the subseries of the time series data of each of the states can be aggregated and processed in the already defined ways as the full original unstructured time series. For examples we can compute a state specific asset correlation matrix, as noted in block 412 of FIG. 4, or asset return vector. Transforming the asset correlation matrix of a specific state to a dissimilarity matrix of that state and doing these transformations for all states enables the system to compute the dissimilarity of states and thus their hierarchical or partitional clustering or their network structure. This reveals the relations of the states, which enables the system to detect outlier states.

It is also possible to evaluate/rank each state by means of the subseries of financial data and/or the additional information sets like weights/limits/constraints. For example, the system could compute the performance and risk of an investment portfolio in each state, conditional on some weight assumption, as noted in block 804 of FIG. 8, and then do a ranking based on the results, as noted in block 806 of FIG. 8. The system could also evaluate a state in terms of its diversification properties, like network concentration, as well as number/structure/compactness of the state conditional clusters and networks, as noted in blocks 704 and 706 of FIG. 7. For example, very few clusters, a high average correlation, a contracted correlation network, and a high risk measure like Value-at-Risk of an investment portfolio in a specific state, characterize this state as very bad in terms of risk and stress and lack of performance.

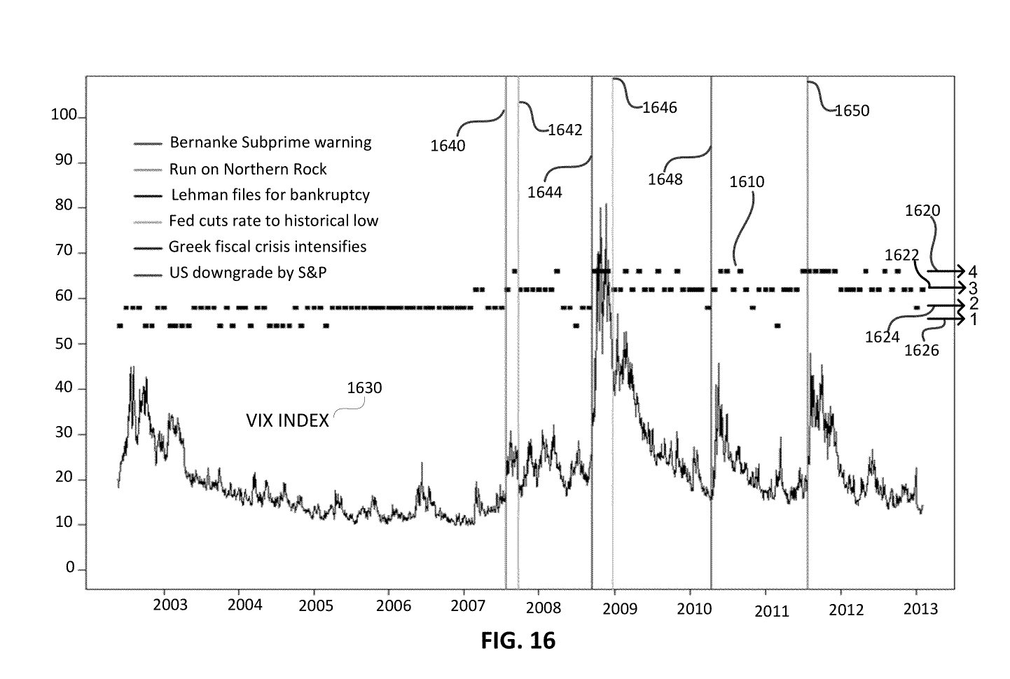

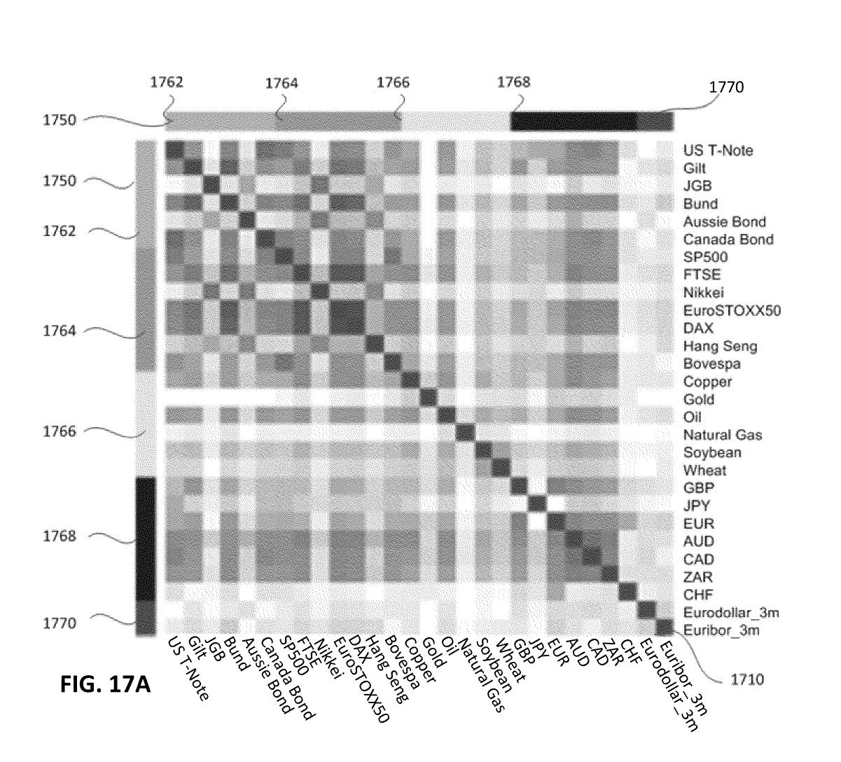

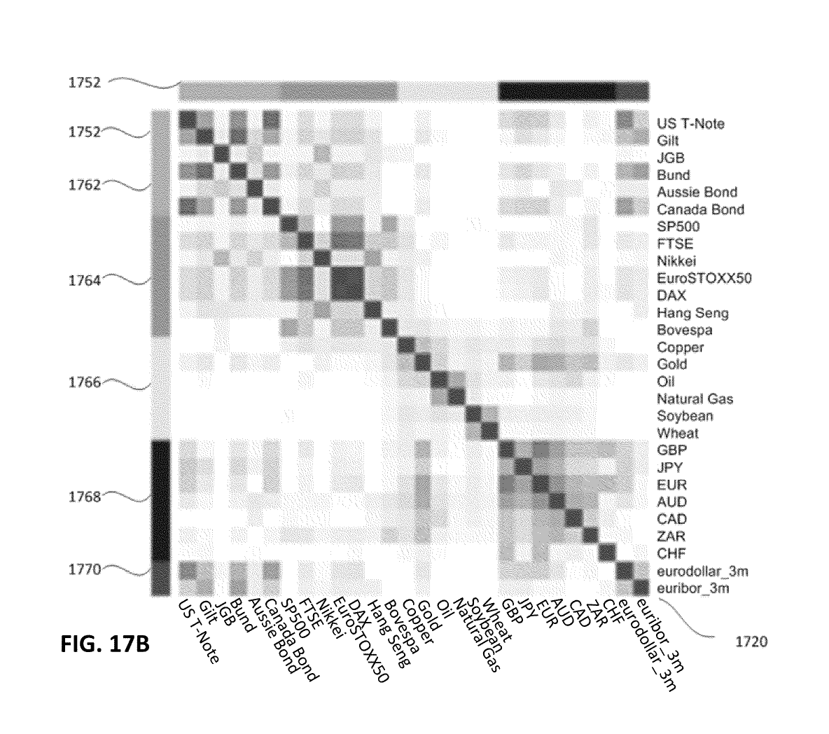

The outcome of the state detections and evaluations can be seen in FIG. 16a. To generate that figure, monthly time windows were used among 28 assets in order to extract k=4 states. The black dots, e.g., dot 1610, mark the memberships of the monthly time windows to the 4 states, which are depicted using four different horizontal levels 1620, 1622, 1624 and 1626 aligning the black dots and four red arrows labelling the four states 1, 2, 3 and 4. Also shown in FIG. 16a is an external market risk seismograph 1630 (the VIX implied volatility index) that helps to evaluate the states in terms of risk. The vertical lines (1640, 1642, 1644, 1646, 1648, and 1650) illustrate specific market crisis events (1652, 1654, 1656, 1658, 1660, and 1662, respectively). FIG. 17 shows plots of the correlation matrices of two different states represented as correlation heat maps 1710, 1720 of 28 assets. In this example, shading levels are used to designate different levels of correlation. In other embodiments, specific shading levels combined with specific colors (e.g., red) can be used to designate varying levels of correlation while specific shading levels combined with other colors (e.g., blue) can be used to designate varying levels of anti-correlation. As can be seen from FIG. 17, the correlation patterns are very different in the two states. The shaded bars 1750, 1752 above and besides the matrices mark the asset classes the individual markets belong to: fixed income 1762, equity indices 1764, commodities 1766, currencies 1768 and money market futures 1770. These shaded bars 1750, 1752 are colored bars in some embodiments.

The state finding procedures described above considers the whole portfolio without the need to know the weights assigned in any given portfolio. Since all assets in the set are treated equally, those state finding procedures are essentially equivalent to finding states in a portfolio in which the assets have equal weight. As a result, the state evaluations in terms of performance and risk measures could also be generated by an equal weight portfolio for consistency. An alternative state evaluation could be the measurement of portfolio risk and performance based on the time series, including weight assumptions. Under either approach, these evaluation techniques are noted in block 804 of FIG. 8.

In some embodiments, determining performance characteristics of a group of assets can be done with one or more assets that are overlapping, or, in an extreme case, independent of the predefined group of assets used to generate the states. In other words, even when states are generated based on the financial data for a particular group of assets, that state information may be used to evaluate the performance of assets independent of that particular group.

Having assigned the state evaluations in terms of performance, risk and other properties it is possible to rank the states, as noted in block 806 in FIG. 8. Since the states represent all possible distinct variations of the universe of characterization of time periods, it is possible to design portfolios with improved performance in each of the possible states. Alternatively, the system can simply focus on the state with the lowest rank (i.e., the “worst” state). During this process, it can be highly informative to analyze the state's asset correlations, asset clusterings, and asset network structures because they provide a snap shot of the asset relationships during crises. These are the “correlations at risk” or “clusters at risk” or “networks at risk.”

It is also possible to evaluate a state by means of additional assets or time series that are not based on the original set of assets. This could be a related index or benchmarks, ETFs, and funds or fund-of-funds or derivatives.

Another form of evaluation of the states is based on the networks and clusters themselves. It can be stated that, in time of market stress, network topologies and cluster formations are very specific. For example, a network centralization coefficient describes how “star-like” or “chain-like” a network is. Since there are typical shapes in times of market stress, this measure can evaluate different states in terms of their crisis character. Similarly, the system can observe how contracted a network is in times of market stress.

In addition, the shape, depth, and “nestedness” of a hierarchical clustering provides another way to evaluate states. Likewise, partitional clusterings can be used to evaluate states. In particular, the states can be compared to some external classification (e.g., asset classes or industry partitions). In relatively calm market phases, these external classifications are assumed to perform in a similar fashion (e.g., as measured by the Rand index) and in times of stress they are expected to deviate. For example, the number of clusters in times of stress can be reduced and these clusters are more compact in times of stress. Respective partitions for this analysis can also be generated by partitioning networks or dendrograms. For example, a network has several dense regions called communities. These are like clusters but are generated in the network context.

Another technique for evaluating a state is focusing on a central industry sector, like the financial industry within a broad market index. The relative network or cluster position of this industry can be measured in each state. In normal market periods, the financial industry is expected to exhibit a central role in the economy. In context of this analysis, it is also possible to compute the risk contributions of each industry sector or cluster and/or the disparity of equal risk contribution of the sectors or clusters. These numbers are also helpful to evaluate the different states.

The techniques and embodiments discussed herein cover the full spectrum of modern risk management like early warning for crises, investment opportunities, and structural breaks. Other risk management applications that may be used in conjunction with embodiments discussed herein are stress testing, scenario analysis, risk protection and diversification, and forecasting of risk and investment chances. Below are some additional examples of how embodiments of the invention may be used:

Early Warning:

The transition probabilities, noted in block 604 in FIG. 6, to other states can be informative. These can be modelled by machine learning algorithms like finite-state machines. An example of a memoryless procedure is a Markov chain, which is a mathematical procedure that undergoes transitions from one state to another on a state space. It is a random process usually characterized as memoryless: the next state depends only on the current state and not on the sequence of events that preceded it. Based on the transition matrix, the system can forecast the state of the next period by the knowledge about the current state and the transition probability table. It is then known how the relationship characteristics, like correlations and the performance/risk numbers, might look like in the future state, since an expectation value for these quantities can be computed using the probability table and the respective quantities for the data history of the states in the past. Another way to forecast a state is estimating future correlations or returns with another model and then comparing the resulting characteristics to the past states or time periods. The past time periods or states with the smallest distance to the estimated future state are important as their evaluations and characteristics might apply in the near future.

The evolution of states through time follows certain paths and patterns. These paths are basically trajectories of state transitions. The space of pathways can be defined and probabilities to certain paths can be computed. For example, consider in general a model with two stable states A and B. The model will spend a long time in those states and occasionally jump from one to the other. There are many ways or pathways in which the transition can take place. Once a probability is assigned to each of the many pathways, one can construct a randomized sampling in the path space of the transition trajectories, and thus generate the variety of all transition paths. All the relevant information can then be extracted from the variety, such as the reaction mechanism, the transition states, and the rate constants. Very rare states can be sampled in this non-equilibrium, non-stationary construct.

These state transition models, finite state machines, or Markov chain models can be visualized by state transition networks or diagrams. These networks or diagrams can be based either on memoryless approaches like the Markov chain or on the path trajectories.

When there are new time periods arriving due the proceeding of time, those new time periods can be added to the states in a similar way in which the “old states” were created. If the new time periods (e.g., the characteristics of the financial data in the new time periods) are very dissimilar to the known states' characteristics, a new state can be created. This architecture allows easily updating a model with respect to tracking the transitions and the path space of the transition trajectories.

In other words, the modelling of transition probabilities, transition trajectory probabilities and other information based on the state transitions enables the system to forecast the next future state, or to forecast the asset relationships. The system is also able to identify if there is historical break in the asset relationships and how this new asset relation equilibrium looks like in detail on an asset-specific level.

Each state has state-specific asset relationship characteristics like an asset correlation matrix. Since one or more states of the plurality of states can have their own asset correlation matrices, the distances of these states can be computed just is a similar manner to comparing the distances of the time periods' asset correlation matrices discussed above. The distance matrix of a number of states can thus be the input of a network or clustering approach. A clustering or network model of states reveals the relations of the states to each other in detail. For example, having generated a network where each node is a state allows us to reduce this network by a community detection algorithm.

A state transition network can be also be reduced by a community detection algorithm. Links between the communities are updated with respect to the containing links of the community members. In this way, a state transition network is strongly reduced and only the major state communities are shown, analyzed, and visualized.

Situation Analysis:

in risk management it can be important to analyze the current situation and put it into risk perspective. Embodiments of the invention evaluate the current asset relationships and immediately evaluate present dynamics with reference to the known and evaluated states. For example, if a network contraction pattern evolves in a manner that is found in a past state, the system can quickly identify an evolving risk situation or a performance break-down. A network contraction pattern could be the measurement of the network centralization coefficient of a sequence of networks; when the network gets more star like, a risk might be emerging. Another example of a risk situation is a turbulence of state transitions occurring in the near past. Yet another example is a macroeconomic shock hitting many assets which are related: these could be in the same cluster and therefore the risk of a contagion effect emerges.

Consistent and Forward Carrying Risk Histories:

historic return time series carry a lot of information that, properly evaluated, enables the system to design a favorable risk profile for the future. Thus, in some embodiments the system is designed as a live risk cockpit that constantly evaluates fresh data series and consistently puts them into perspective. This forward carrying risk evaluation immediately recognizes structural breaks and inflection points, for example, if the latest data is very dissimilar to all known states and time periods. Also, it is possible to analyze those new states from all dimensions like risk, performance and relationships.

The permanent evaluation of current and past data can be important for some embodiments, as this can be a starting point for extensive scenario analysis and stress testing. The states basically comprise all possible situations the markets can be in. Current portfolios can be evaluated with the data of all states, and especially with the worst states, for consistent stress testing. This in turn gives new indications on how to engineer a portfolio in order to reduce and prevent crisis impacts and hedge away tail risk. This drives portfolios to less fragility. Also, the signals and indications could be used to build up short positions which outperform in times of crisis and therefore make portfolios even anti-fragile.

Diversification Engineering:

Focusing on a crisis state allows the system to analyze the relationships and evaluations in times of market stress. For example, it can be measured how evenly risk is distributed across the clusters or it can be measured how much risk is contributed by each cluster. It is then possible to engineer a portfolio diversification that is less impacted by the stress relationships. For example, there can be “low crisis beta” which means these portfolios have a very different behavior as the market (“beta”) has. They are de-correlated from market crises.

Focusing on single assets allows the system to study the role of individual assets/markets in the complex organization of portfolio relationships. For example, central network assets that exhibit high risk contributions might be eliminated from the portfolio because of their significant contributions to risk concentrations. This can be highly interesting for more static portfolios, where only a few assets are allowed to be sorted out. If there are more assets in the portfolio and a greater degree of freedom is provided to exclude assets from the portfolio, in some embodiments the system will keep assets with a low network or cluster centrality because, in this case, even a relatively low number of assets is able to maintain a certain degree of diversification since these assets are highly dissimilar by construction.

Another important aspect of certain embodiments is the ability to identify and monitor asset relationship dynamics. For example, if there are two consecutive states in which the relationships between a particular asset and the other assets vary between the two states, the system can track the function like position of that particular asset in a clustering or network model. Expanding that tracking function to all the assets in the set of assets collectively highlights the cluster and network formations at state transitions. This is possible, since we deal with the same set of assets here and only the clusterings or network topologies of this set change across the states. Since we apply the same clustering algorithms and network generations on the same set of assets and only the time periods or states are changing we have a controlled environment where we are able to track the changes in the model.

Risk Model Calibration:

it is often unclear which time series to use as model input without being procyclical. In some embodiments, one approach is to collect time series from states that are similar to a current situation. This stabilizes model calibrations and out-of-sample model quality. Also, it is possible to use a weighted model input based on the weights of several states. Crisis related states, for example, could receive a higher weight in order to alter the portfolio to be more risk averse.

Impact Analysis of Market Events:

there are market events, like large-scale liquidity injections of central banks, that shake the asset relationships for a relatively brief time period. After these brief time periods, the relationships either settle into a new market equilibrium/state or recover to an old state. This can influence opinions of the global macroeconomic development and may have an impact on asset allocation, risk management and portfolio construction. Therefore, reporting the time evolution of the assigned states can give market practitioners a quantitative insight about the reaction of the market to recent market events.

Proxy Hedging:

In practice it is sometimes not possible to hedge some markets directly because they can be illiquid or too expensive to enter. Proxies are needed which are investable and have a very similar hedging effect as the direct hedge. The neighborhood relationships in the networks and clusters offer candidates for proxy hedging.

Model Risk Mitigation:

in many of the embodiments discussed herein, the system is designed to rely primarily on the actual financial data, as opposed to significant assumptions, in order to decrease model outcome risk. In addition, model outcome quality and significance are tracked, so that out-of-sample stability is increased and the impact of chance is reduced. Also, the number of parameters can be relatively low with those particular parameters being tractable parameters.

Various embodiments discussed above generate a variety of signals and patterns for investment management practices like asset allocation, portfolio construction, and establishing trading strategies. Especially in trading, it can be helpful to allow shorting some assets or leverage. Basically, in the absence of risk and presence of diversification, there would be more long positions and vice versa: in risky and concentrated states there would be more short positions due to the increased downside potential. In some embodiments, the system is used to execute investment management applications in such scenarios. Exemplary applications that may be executed according to various embodiments discussed herein are described below.

“All-Weather-Portfolio”:

Knowing all states and their evaluations it is possible to not only construct a portfolio with lowest impact of the worst state (like in the risk management section) but rather a portfolio with a favorable profile of performance, risk and diversification in several or even all states of the plurality of states (“all-weather-portfolio”).

Global Macro Events:

an example of global macroeconomic events are huge liquidity injections/operations and quantitative easing of central banks. These events impact the relationships of assets in certain patterns, which can be extracted out by some of the techniques discussed above. It is thus possible to construct profitable trading strategies when a known pattern arises. One example is similar to pairs trading: a clique of assets in a network seems to be statistically stable over time. At an infliction point, where this equilibrium is disturbed, it is possible to cointegratively bet on a reoccurrence of the correlation clique.

Portable Trade Signals in Portfolio Construction/Allocation:

Allocating risk capital on assets or segments is often done by collecting characteristics of the assets/segments/industries forming part of the input of optimization programs that construct portfolios. These optimization programs are typically set up to meet a particular objective, like a utility or risk aversion function that the user defined beforehand. These characteristics of assets/segments/industries could be long/neutral/short signals which are ported to the optimization algorithm. The signals can be generated by several methods including a network approach indicates the buying of decentral assets and the selling of central assets, for example.

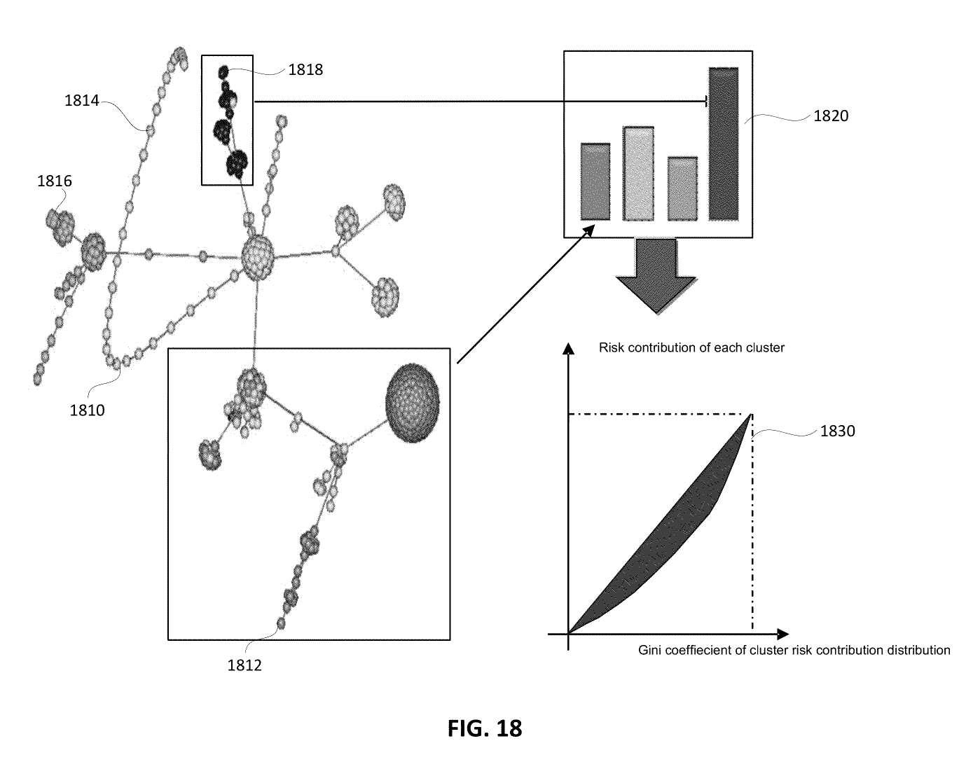

In situations where there is a timing aspect to the analysis, e.g., a particular window in which certain signals have the most influence in different market phases, the network approach could again be included. In particular, network contractions could, for example, indicate the emergence of a stressful market period. Besides the long/neutral/short signals that are based on network centrality, other asset specific information could be used, like an asset's expected return or risk. A portfolio could be constructed with assets of high quality and low centrality. A starting point for such a rather heuristic approach would be to optimize the portfolio with respect to its risk and/or return by a Markowitz or Minimum Variance approach, which are techniques readily understood by those of ordinary skill in the art. This weight is then combined with the network approach and more sophisticated but commonly used risk measures like CVaR. Also, the community or partitional cluster structure could be used to avoid concentrations if too many very similar assets were chosen in the set of decentral assets. The risk concentrations could for example be balanced by the community weights like in FIG. 18. On the left hand side of FIG. 18 is a minimal spanning tree 1810 of a portfolio. A community/cluster detection algorithm has identified four communities/clusters, 1812, 1814, 1816, and 1818, which are depicted with different shades. In other embodiments, varying colors or other indicia may be used instead of shading. The risk contributions of each asset to portfolio risk are computed and summed within each cluster, which result in the cluster risk contributions chart 1820. As one of ordinary skill will appreciate, there are other ways to compute and depict the cluster risk contribution. It can be seen that the cluster risk contributions are unevenly distributed. This is expressed as the Gini coefficient which is shaded in the chart 1830. The Gini coefficient is a mathematical approach that is well understood in the art.

The asset weights are summed within each network community and the equality of the community weights is measured by the Gini coefficient. Portfolios can be trimmed to get a more equal distribution of weights across clusters or communities. Instead of portfolio weights, the clusters/communities could also be weighted by their risk contributions. The purpose is to design equal risk cluster contributions.

Protection from Coordinated Tail Risk:

In some embodiments, the system measures, for example, using non-linear techniques, the frequency of coordinated “jumps” to extremes of two assets. One example is the tail dependence coefficient. It measures how often two assets tend to have large negative returns at the same time. A matrix of such measure resembles a distance matrix, which can be the input of a network generation operation. The resulting central nodes of the networks or clusters resemble assets that tend to “jump” to very negative returns at the same time as many surrounding assets. Reducing their weight impact will protect the portfolio from adverse asset relationships. The system can focus particular states in which these “jumps” occur. As a result, the system is able to address the coordinated default of asset groups in times of crisis.

State-Dependent Investment Recommendations:

In some embodiments, the system can select from one of a plurality of investment recommendations based on a classification of the current state or a forecast of a future state and according to the existing experience with this recommendation during past occurrences of this state. The investment recommendations could differ in their parameters, their trading rules or their asset allocations.

In some embodiments, the system is configured to support Interactive Reporting, Cockpit Functions and Visualization Algorithms. In particular, network layouts can, for example, be generated by force-based visualization algorithms. Force-directed graph drawing requires no special knowledge about the graphs, like a graphs planarity property. They are physical simulations where network nodes push each other off and edges keep nodes closer to each other. There are optimization objectives and constraints in this model, like keeping the edges at the same length, letting their length scale with some edge property like correlation, and minimizing edge crossings. The result of this forced-based simulation in equilibrium should be an aesthetically pleasing graph layout in 2D or 3D or even 4D (for a sequence of networks). The success of such a layout can be measured in terms of how much the objectives and constraints are met. These force-based algorithms can be implemented in an online mode, where the forces are simulated permanently and the objectives and constraints are optimized. In this manner, graph events like adding or deleting a node/edge can be considered in the force simulation immediately (i.e., in real-time). Single events like adding a node can also come in a sequence and pushed to the force simulation as a package of events. Sizes, colors, labels and other graphical elements of nodes and edges are visualized in correspondence of all proposed asset evaluation measures like risk, cluster membership, tail dependence coefficient, for example. An example is the coloring of industry memberships or scaling the node size with network centrality.

These force-based algorithms also allow for a stream of network events, like erasing a link or adding a link. The event is realized within the network topology and the force-based algorithm rearranges the network in order to find a new equilibrium. Network events occur when there is a transition of states being triggered by the user of the visualization cockpit. Edges can also be scaled with respect to edge weight.

In order to minimize the rearrangements of a network during state transitions, there are algorithms that provide a graphical user interface that reduces the amount of non-information-carrying movements in the network. Partitional clusters can be visualized as a cluster stream when they are modelled, like networks whose topologies are updated within the force-based environment. This is done by adding links with all members of each cluster, such that there is a network forest where each cluster corresponds to a sub network and none of the clusters are linked at the same time. Rewirings occur when the cluster formations change at a state transition.

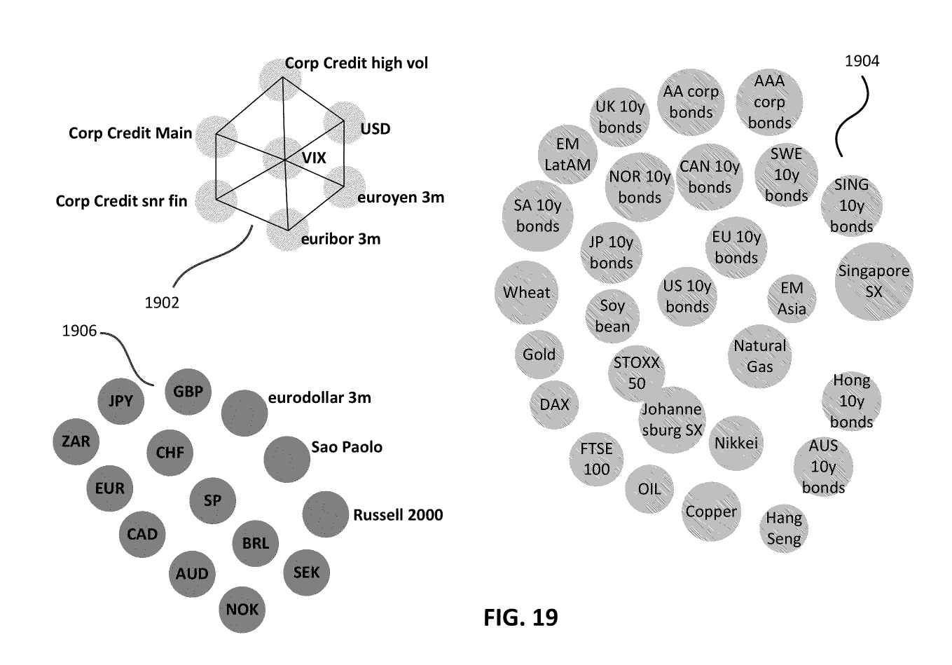

An example of this technique is shown in FIG. 19, which illustrates clusters 1902, 1904, and 1906 generated as discussed above. In this figure, the links in the clusters 1902, 1904, and 1906 are made transparent and the force-based algorithm is switched on. Each node is one asset. The colors or shadings of the three clusters correspond to the cluster membership. The layout is created by connecting all nodes of one asset cluster as shown in the upper cluster 1902. In the final visualization, the edge connections are made invisible, e.g., by choosing the same color as the background. The nodes/edges are given no xy-coordinates but they are pushed to a forced-based online algorithm; nodes push each other off and edges pull the nodes together. Since only the nodes in one cluster are connected, they group according to the clusters. At a transition to another state there is another cluster structure, so some nodes change from one cluster to another. When releasing edges and building new edges in the online force algorithm, the nodes seem to “fly” from one cluster to another. So, in summary, the changing cluster structures at state transitions are streamed into a force-based online layout algorithm. The cluster colors can be chosen dynamically. For example, the clusters could be colored according to asset class. Then one could see how the asset classes are distributed across asset clusters. Normal market times can be represented by clusters mostly corresponding to asset classes. In times of crisis there are far less clusters. The correspondence of asset classes with clusters can be computed by the (corrected) Rand index. The Rand index is a measure of the similarity between two clusterings. It has a value between 0 and 1, with 0 indicating that the two clusters do not agree on any pair of points and 1 indicating that data clusters are exactly the same.

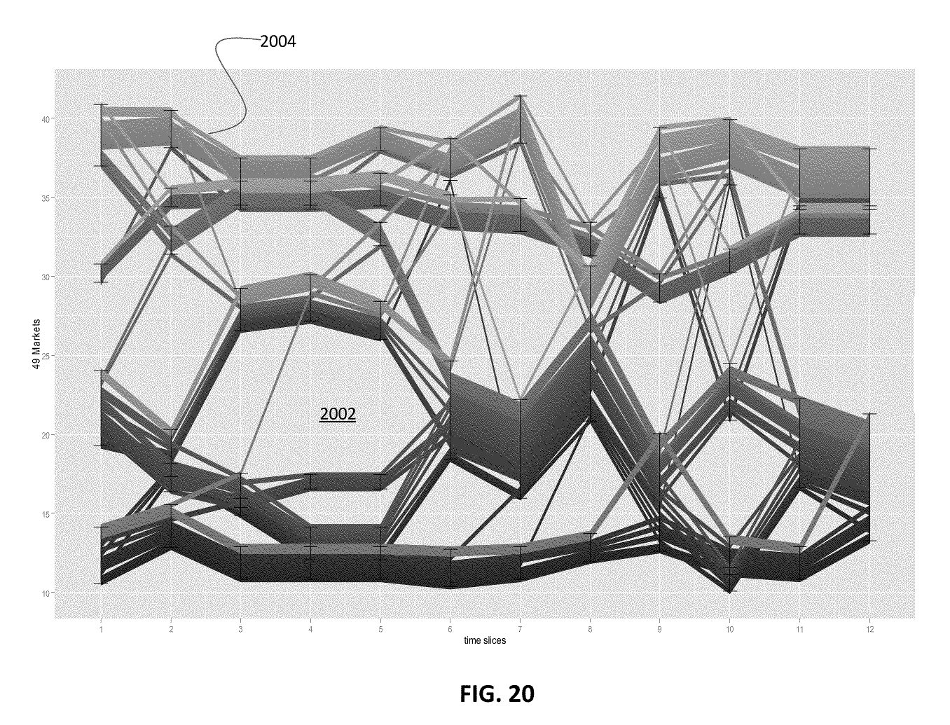

Knowing the cluster memberships of each asset in each state enables the system to track the clusters at state transitions. Since the specific cluster number at a state-conditional clustering has no meaning, the cluster sets of all states have to be analyzed with respect to the cluster memberships in each state. For example, if assets A and B are in the same cluster as C in one state and in another state assets A and B are only together with D, it can be stated that the cluster which contains A and B has the same origin in both states. One way to visualize this is shown in FIG. 20. In that figure, a graph 2002 includes lines, e.g., line 2004, that track assets through the clusters. The layout can be optimized in a way that the lines for the assets cross as little as possible. The cluster formations due to state transitions then become visible.

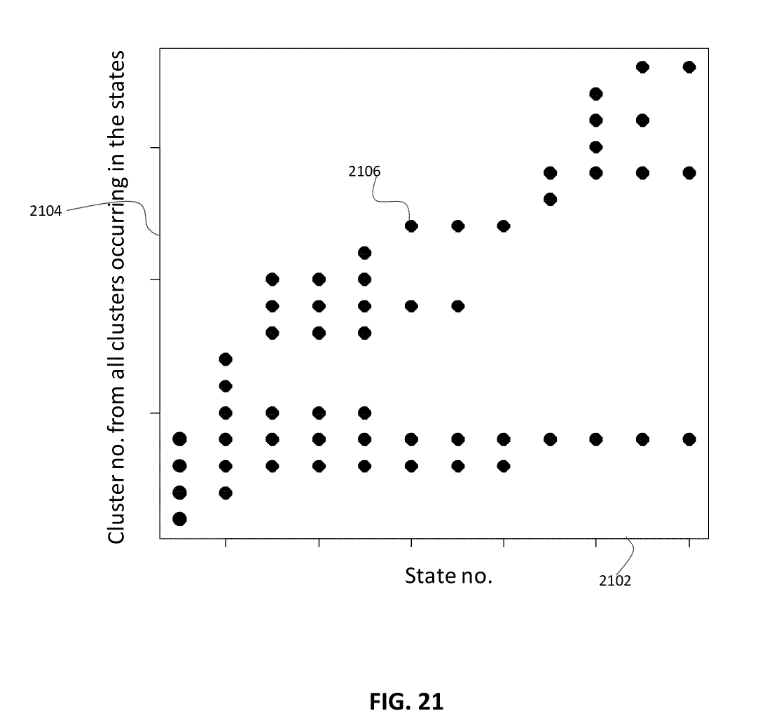

In some embodiments, the system computes the cluster identity by comparing the degree of convenient memberships of the cluster sets of different states: if there is a particular degree of overlap, e.g., about 50% or more, the system determines that the cluster is the same in both states. A graphical user interface could then identify that cluster with indicia (e.g., color) that identifies that cluster as pertaining to the same states. With this method it is possible to analyze the clusters through the cycles of states: clusters are born or disappear, or clusters expand, merge shrink or split. From this information the system can create and display the chart shown in FIG. 21. The x-axis 2102 indicates the number of states and y-axis 2104 indicates the cluster staples: if there is a new cluster born, it plotted using a dot (e.g., dot 2106) located on a higher level on the y-axis 2104 than the last new cluster.

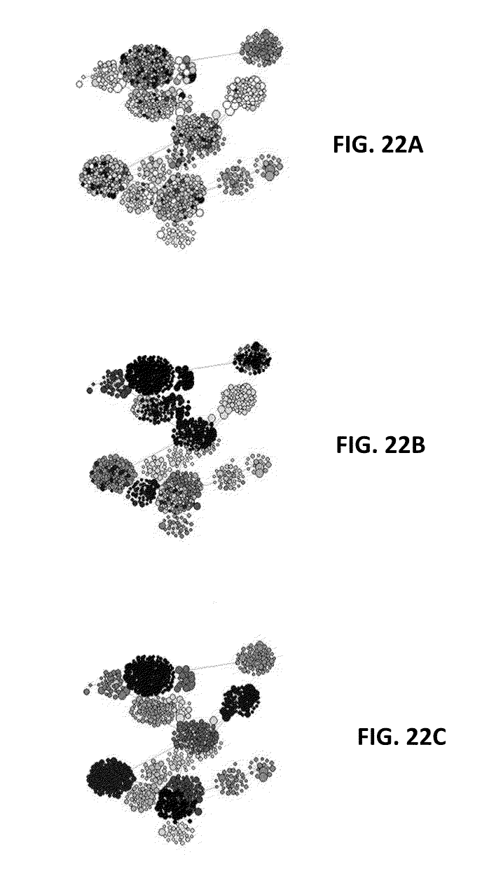

In some embodiments, and as shown in FIGS. 22A-C, the system depicts the same correlation network for a set of assets using different shading or color schemes. The two first indicia schemes correspond to industry (FIG. 22A) and country of origin (FIG. 22B) of the assets. The last scheme (FIG. 22C) corresponds to the communities of the network found by some community detection algorithm. It can be seen that the two first classifications do not correspond so well to the network structure in comparison to the network-based classification.

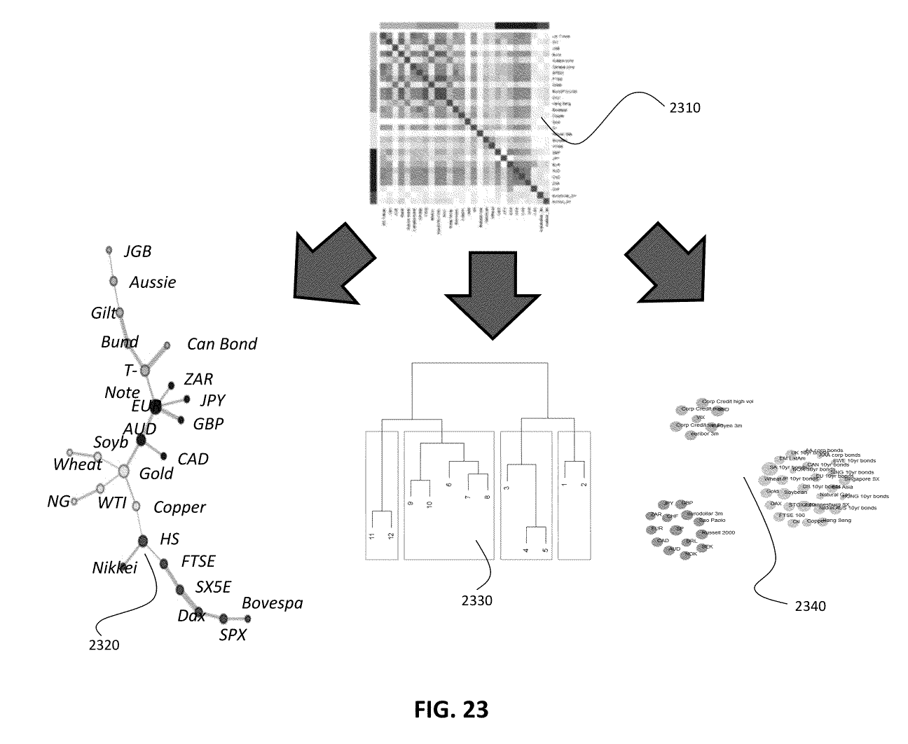

Thus, as shown in FIG. 23, state information can be depicted using several different mechanisms. For example, the state information can be portrayed using a matrix 2310 along with shaded or colored bars, as detailed above with respect to FIG. 17. That information may be used to create a filtered network 2320, in which the assets are nodes of the network, the relationship information constitutes the links between the nodes, and the shading or coloring conveys state information for the assets, as detailed above with respect to FIG. 15. The state information may also be conveyed using a dendrogram 2330 or a clustering diagram 2340, as shown in FIG. 23 and detailed above with respect to FIGS. 14 and 19, respectively.

In some embodiments, the system is adapted to generate a plurality of states using the financial data for a group of assets, as described above. The system is further adapted to generate three informational sets based on the state information. In particular, these informational sets include: 1) analysis of an asset correlation by means of network models and/or clustering; 2) a marginal evaluation of each asset in terms of prospective performance, risk and risk contribution; and 3) a portfolio evaluation in terms of performance/risk from which a risk contribution on asset level can be computed. The system may also generate an asset correlation matrix based on a state or a time period. The system is further adapted to use a set of rules to construct a portfolio from these information sets.

An exemplary, straightforward technique to do this is ranking and rank aggregation is as follows. The assets are first ranked in two of the three information sets so we have, in a particular example,:

1. A ranking of assets with respect to their network centrality. A decentral asset could have a good ranking Note that this is a ranking based on the function or role of an asset in a network—the ranking could also be based on the function or role of an asset in a clustering.
2. A ranking of assets in their marginal performance/risk measure: for example, an asset with a high risk-adjusted expected performance has a good ranking
3. A ranking of assets with respect to their risk contribution to portfolio risk: an asset with low contribution has a high ranking

For each of the three information sets there is a ranking vector which has the dimension of the number of assets. The asset ranking vectors of one or more of the three information sets can now be aggregated. A standard way to do this is by adding the ranking vectors on an asset level. The resulting aggregated vector maintains the dimension of the number of assets. This aggregation can be ranked again, which results in a final evaluation of each asset in terms of its positive or negative network/clustering function, in terms of its performance/risk, and in terms of its risk contribution. From this evaluation one could construct a tailored particular investment strategy like the following: selecting a number of assets with good figures of risk, performance, and risk contribution and with a decentral and therefore diversifying function in a network or cluster model. As a result the system can select very independent assets with very good risk adjusted prospective performance. In a portfolio construction, the system fills the portfolio with the best assets first. In this step there could be other objectives and constraints involved, e.g., a maximum weight or a minimum risk contribution or a high risk adjusted portfolio performance. The whole portfolio construction can be set up as a search heuristic with constraints or like an optimization problem with an algorithm guaranteeing to find a global maximum within a time limit. One objective could be to keep the weighted average of asset rankings high and a second objective could be to minimize some portfolio risk measure. A starting value for the search heuristic could be the weights of a mean-variance optimization, so the heuristic starts its work on a pre-optimized level. Note, that a portfolio risk or performance measure can help to evaluate the effectiveness and validity of the rankings-based approach in that the suggested weight vector from the rankings-based approach is used as input for a measurement of the prospective portfolio performance/risk. Note that it is also possible to add a cluster analysis to the procedure described above. This would be another information set that can be easily included in the rank aggregation technique. For example, the objective in a portfolio construction could be to distribute the portfolio weights equally across clusters, as a cluster is a set of similar assets with similar risk characteristics. Accordingly, having invested too heavily on a single cluster is risky, since all the assets in a cluster are strongly correlated.

Another way of aggregation is to first use a network approach to select a subset of assets first and then proceed with an arbitrary portfolio construction technique. Thus, these information sets can be used in a sequence or in unison to construct a portfolio. Another possibility is to use the asset rank information in one or more constraints of a separated, external portfolio optimization program.

As outlined before, in some embodiments, the system computes several partitional clusterings of the same set of assets. The assets of each cluster are connected by links in all combinations. Between the clusters there is no link. This structure is the input to an online force-based visualization layout algorithm. When there is a change from one clustering to another, rewiring of links occur due to the changed cluster structure. As all rewiring occurs at the change time, the transition of the cluster structure becomes visual in the force-based online layout.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

We claim:

1. A processor-based system for portfolio management, the system comprising:
a first tangible, non-transitory storage medium adapted to store sets of time series of financial data for a predefined group of investment assets, the sets of time series spanning a set of predefined time periods;
a second tangible, non-transitory storage medium adapted to store information identifying assets in an investment portfolio;
one or more processors operatively coupled to the first tangible, non-transitory storage medium to access the sets of time series of financial data and to the second tangible, non-transitory storage medium to access the information identifying assets in the investment portfolio, the one or more processors being adapted to:
compute a plurality of relationship characteristics with respect to the financial data for the predefined group of investment assets, with each relationship characteristic of the plurality of relationship characteristics corresponding to a time period of the plurality of predefined time periods;
compute pair-wise similarity measures between each of the relationship characteristics;
determine groupings of similar relationship characteristics using the pair-wise similarity measures in order to define a plurality of states; and
evaluate the investment portfolio in at least one of the plurality of states by computing a performance measure based on the financial data time series for each asset in the investment portfolio in the at least one state of the plurality of states.

2. The processor-based system of claim 1, wherein the one or more processors are further adapted to modify weightings of the assets in the investment portfolio based on the evaluated performance of the investment portfolio in the at least one state of the plurality of states.

3. The processor-based system of claim 2, wherein the one or more processors are further adapted to identify an state of the plurality of states in which a performance measure of the investment portfolio in that state is worse than a predefined threshold, and wherein the one or more processors are further adapted to modify weightings of the assets of the investment portfolio in order to improve the performance of the investment portfolio for that state.

4. The processor-based system of claim 3, further comprising a display, wherein the one or more processors are adapted to convey the modified weightings of the assets of the investment portfolio using the display.

5. The processor-based system of claim 1, further comprising a display, wherein the one or more processors are adapted to convey the performance measure in the at least one state using the display.

6. The processor-based system of claim 1, wherein the one or more processors are further adapted to rank each state of the plurality of states according to the performance measure for the investment portfolio in each state.

7. The processor-based system of claim 1, wherein the one or more processors are further adapted to compute a transition probability for transitions between each state of the plurality of states.

8. The processor-based system of claim 7, wherein the one or more processors are further adapted to modify weightings of the assets of the investment portfolio based on the transition probabilities.

9. The processor-based system of claim 1, wherein the assets of the investment portfolio consist essentially of assets of the predefined group of assets.

10. The processor-based system of claim 1, wherein the one or more processors are further adapted to construct, for at least one state of the plurality of states, a network model of assets in the at least one state, the network model comprising:
a plurality of nodes, each of the nodes representing one asset;
a plurality of edges, each edge linking two nodes of the plurality of nodes and representing a relationship value for the assets of the nodes linked by the edge in the at least one state, wherein the relationship values represented by the plurality of edges correspond to a representative relationship matrix for the assets in the at least one state.

11. The processor-based system of claim 10, further comprising a display, wherein the one or more processors are adapted to convey a graphical representation of the network model of the assets in the at least one state using the display.

12. The processor-based system of claim 10, wherein the one or more processors are further adapted to determine a function of at least one asset within the network model and to change a weighting of the at least one asset in a portfolio based on the function of the at least one asset within the network model.

13. The processor-based system of claim 1, wherein the one or more processors are further adapted to construct, for at least one state of the plurality of states, a hierarchical or partitional cluster model for assets in the at least one state, wherein constructing the hierarchical or partitional cluster model includes grouping the assets into overlapping or non-overlapping clusters based on a transformation of a representative relationship matrix for the assets in the at least one state

14. The processor-based system of claim 13, further comprising a display, wherein the one or more processors are adapted to convey a graphical representation of the cluster model for the assets in the at least one state using the display.

15. The processor-based system of claim 13, wherein the one or more processors are further adapted to determine a function of at least one asset within the cluster model and to change a weighting of the at least one asset in a portfolio based on the function of the at least one asset within the cluster model.

16. A method for risk management for an investment portfolio that includes assets selected from investment markets, the method comprising:
creating, using one or more processors operatively coupled to a tangible, non-transitory medium in which financial data for assets in investment markets are stored, a plurality of states that each comprise discontinuous time segments in which financial data for these assets exhibit similar relationship characteristics as determined by a clustering algorithm;
evaluating, using the one or more processors, a performance characteristic for the investment portfolio in at least one of the states using the financial data stored in the tangible, non-transitory medium; and
modifying, using the one or more processors, the investment portfolio in order to improve the performance characteristics for the investment portfolio in at least one of the states.

17. The method of claim 16, the method further comprising:
creating a correlation matrix for each of the plurality of states;
creating, using the one or more processors, a new correlation matrix for the assets in the investment markets over an additional time segment; and
determining, using the one or more processors, similarity measures between the new correlation matrix and each of the correlation matrices for the states of the plurality of states.

18. The method of claim 17, the method further comprising a step of merging the new correlation matrix and the correlation matrix for a particular state.

19. The method of claim 17, the method further comprising a step of establishing a new state that includes the new correlation matrix.

20. The method of claim 19, further comprising:
evaluating, using the one or more processors, a performance characteristic for the investment portfolio in each state of the plurality of states, including the new state; and
modifying, using the one or more processors, the investment portfolio in order to improve performance characteristics of the investment portfolio in each state of the plurality of states.

21. The method of claim 16, further comprising:
computing, using the one or more processors, transition probabilities between each of the states in of the plurality of states;
identifying a particular state of the plurality of states whose time segments include a current time segment; and
forecasting a probability of a transition from the particular state of the plurality of states to a different state of the plurality of states.

22. The method of claim 21, wherein forecasting the probability of the transition from the particular state of the plurality of states to the different state of the plurality of states includes creating a probability table identifying a probability of a transition from the particular state to each of the remaining states of the plurality of states.

23. The method of claim 22, further comprising a step of displaying the probability table in conjunction with the performance of the investment portfolio for each state of the plurality of states.

24. A computer-implemented method for improving performance of an investment portfolio, the method comprising:
using one or more processors to access financial data for a selected group of assets in an investment market, the financial data being stored in a tangible, non-transitory storage medium;
identifying discrete time segments in which the financial data for the selected group of assets in the investment market have similar correlation characteristics;
grouping the discrete time segments to create states;
creating a correlation matrix for each state using the financial data for the selected group of assets;
identifying assets of the investment market pertaining to an investment portfolio;
analyzing, for at least one state, the financial data for the assets of the investment portfolio during the discrete time segments forming the at least one state to create performance information for the investment portfolio specific to the at least one state.

25. The computer-implemented method of claim 24, further comprising:
analyzing, for at least two states, the financial data for the assets of the investment portfolio during the discrete time segments forming each to create performance information for the investment portfolio specific to each state;
comparing the performance information for the investment portfolio specific to the at least two states to identify at least one state in which the performance information for the investment portfolio is incongruous with at least one predetermined investment goal.

26. The computer-implemented method of claim 24, further comprising a step of modifying the investment portfolio so that the performance information for the at least one state is congruous with at least one predetermined investment goal.

27. The computer-implemented method of claim 24, further comprising a step of modifying the investment portfolio so that the performance information for the portfolio in the at least one state is within a predefined range.
